(19) United States
(12) Patent Application Publication
(10) Pub. No.: US 2025/0375889 A1
(43) Pub. Date: Dec. 11, 2025

(54) TECHNIQUES FOR VISION-BASED ROBOT CONTROL

(71) Applicant: NVIDIA CORPORATION, Santa Clara, CA (US)

(72) Inventors: Xiangyun MENG, Seattle, WA (US); Xuning YANG, Seattle, WA (US); Fabio TOZETO RAMOS, Seattle, WA (US); Dieter FOX, Seattle, WA (US)

(21) Appl. No.: 19/072,884

(22) Filed: Mar. 6, 2025

Related U.S. Application Data
(60) Provisional application No. 63/657,081, filed on Jun. 6, 2024.

(51) Int. Cl. B25J 9/16; G06N 3/0455

(52) U.S. Cl. CPC B25J 9/1697; B25J 9/161; G06N 3/0455

(57) ABSTRACT

Techniques for controlling a robot include receiving sensor data and one or more goal specifications, processing the sensor data, a robot size, and the one or more goal specifications using one or more trained encoders to generate a plurality context tokens, processing the plurality of context tokens using one or more trained decoders to generate a robot plan, and controlling a robot based on the robot plan.

### CROSS-REFERENCE TO RELATED APPLICATIONS

This application claims priority benefit of the United States Provisional Patent Application titled, “VISION-BASED NAVIGATION FOR ROBOT/MOBILE MANIPULATION,” filed on Jun. 6, 2024, and having Ser. No. 63/657,081. The subject matter of this related application is hereby incorporated herein by reference.

### BACKGROUND

### Technical Field

Embodiments of the present disclosure relate generally to computer science, artificial intelligence and machine learning, and robot control and, more specifically, to techniques for vision-based robot control.

### Description of the Related Art

Vision-based robot control is a field in artificial intelligence that enables robots to perceive the environment, make decisions, and perform tasks by processing visual data, such as red-green-blue images with depth (RGB-D) information, LiDAR (light detection and ranging) scans, and/or the like. Vision-based robot control systems have been applied in both robot manipulation and navigation, allowing robots to interact with their surroundings and move through challenging environments. In robot manipulation, vision-based control enables robots to identify, grasp, and manipulate objects. Robots equipped with vision-based control systems can plan paths, avoid obstacles, and adapt to changes in the surroundings. Examples include warehouse robots that retrieve and transport items, delivery robots that navigate urban streets, and agricultural robots that move through fields to perform planting or harvesting tasks.

Conventional approaches for vision-based robot control include predefined models and manually designed pipelines to process visual inputs and generate actions for controlling robots. Such approaches typically use separate modules for perception, planning, and control. The perception module extracts features or object information from input images. The planning module generates a path or motion based on the robot's state and environment. The control module executes the planned actions. For example, conventional approaches for vision-based robot control can use hand-crafted features or pre-trained models for detecting and locating objects within the environment (known as object detection and localization), followed by robot motion planning algorithms, such as A*, rapidly exploring random trees (RRT), and/or the like that plan the trajectory for a robot follow through the environment. For manipulation tasks, conventional approaches for vision-based robot control can use fixed grasping strategies and pre-calculated trajectories based on known object properties.

One drawback of the above approaches for vision-based robot control is the limited adaptability and precision in dynamic or unstructured environments. For example, the above approaches often rely on fixed success criteria, such as defining a task as complete when a robot reaches within a certain radius of a target, which may not suffice for tasks requiring high precision that is less than that radius. For example, a robotic forklift could be required to position itself with centimeter-level accuracy to insert the forks into a pallet without collision. As another example, tasks where a robot is supposed to pick up an object from one location and place the object in another-commonly referred to as pick-and-place tasks-require precise alignment of the robot's gripping mechanism (known as the end effector) to reliably grasp the object without dropping or damaging the object.

Another drawback of the above approaches for vision-based robot control is the dependence on predefined object models or computer-aided design (CAD) files for object localization and manipulation, which restricts the ability of those approaches to handle novel or partially visible objects. For example, a robotic system designed to grasp objects on an assembly line may fail when presented with a new object shape that is not part of a predefined database or when an object is partially occluded from view of the robotic system. Similarly, in warehouse automation, a robot relying on CAD models for object identification may struggle to pick items stored in disorganized or cluttered bins. The reliance on prior knowledge makes the above approaches for vision-based robot control unsuitable for tasks involving unpredictable factors or factors that were not previously observed, such as grasping irregularly shaped objects in recycling facilities, navigating environments where the layout changes frequently, and/or the like.

Yet another drawback of the above approaches for vision-based robot control is that many of these approaches operate on discrete action spaces, meaning the robot can only select from a limited set of predefined actions or movements, such as moving forward by a fixed distance, turning at specific angles, stopping, and/or the like. Discrete action spaces restrict the robot's ability to perform fluid, precise movements required for complex tasks.

Additionally, some conventional approaches train machine learning models to control robots using imprecise datasets, which further reduces the effectiveness in achieving smooth and accurate movements in real-world settings. For example, a model for controlling a delivery robot that is trained on trajectory data that lacks fine-grained detail may cause the delivery robot to move in a jerky or inefficient manner when attempting to navigate busy streets or avoid obstacles in real time.

As the foregoing illustrates, what is needed in the art are more effective techniques for vision-based robot control.

### SUMMARY

According to some embodiments, a computer-implemented method for training a vision-based robot control model includes generating, based on scene data, a plurality of scenes. The method also includes generating, based on the plurality of scenes, one or more goal specifications, and determining, based on the one or more goal specifications and a robot model, one or more robot plans. The method further includes generating, based on the one or more robot plans and the plurality of scenes, simulated sensor data. In addition, the method includes performing one or more training operations to generate a trained vision-based robot control model based on the one or more goal specifications, the one or more robot plans, and the simulated sensor data.

According to some embodiments, a computer-implemented method for controlling a robot includes receiving sensor data and one or more goal specifications. The method also includes processing the sensor data, a robot size, and the one or more goal specifications using one or more trained encoders to generate a plurality context tokens. The method further includes processing the plurality of context tokens using one or more trained decoders to generate a robot plan. In addition, the method includes controlling a robot based on the robot plan.

Further embodiments provide, among other things, non-transitory computer-readable storage media storing instructions and systems configured to implement the method set forth above.

At least one technical advantage of the disclosed techniques relative to the prior art is that the disclosed techniques use a vision-based robot control model to achieve high precision and adaptability in dynamic or unstructured environments. Unlike prior approaches that rely on fixed success criteria, the disclosed techniques enable high precision in robot positioning, including centimeter-level accuracy positioning. The disclosed techniques are also adaptable in that predefined object models or CAD files are not required for object localization and manipulation. A further advantage of the disclosed techniques is the use of continuous action spaces, which enables fluid and precise movements rather than limiting robots to a discrete set of predefined actions. Additionally, the disclosed techniques address the drawbacks of imprecise datasets used in prior art approaches by generating training data based on scene data, which can include predefined object libraries and virtual environments. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of various embodiments;

FIG. 2 is a more detailed illustration of the machine learning server of FIG. 1, according to various embodiments;

FIG. 3 is a more detailed illustration of the computing device of FIG. 1, according to various embodiments;

FIG. 4 is a more detailed illustration of the data generator of FIG. 1, according to various embodiments;

FIG. 5 is a more detailed illustration of the model trainer of FIG. 1, according to various embodiments;

FIG. 6 is a more detailed illustration of the robot control application of FIG. 1, according to various embodiments;

FIG. 7 is a more detailed illustration of the vision-based robot control model of FIG. 1, according to various embodiments;

FIG. 8 is a flow diagram of method steps for generating training data, according to various embodiments;

FIG. 9 is a flow diagram of method steps for training a vision-based robot control model, according to various embodiments;

FIG. 10 is a flow diagram of method steps for controlling a robot, according to various embodiments; and

FIG. 11 is a flow diagram of method steps for generating a robot plan using a trained vision-based robot control model, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for training and using a vision-based robot control model to generate robot plans for controlling a robot to maneuver to precise positions relative to target objects. The vision-based robot control model is trained to process a robot size, a look-at pose, LiDAR (light detection and ranging) inputs, a reference image, and red-green-blue images with depth (RGB-D) inputs to generate a base trajectory, a camera tilt, and, optionally, one or more target object masks. In some embodiments, the model includes a LiDAR encoder, a reference image encoder, an RGB-D encoder, a vision encoder, a context encoder, a target object mask decoder, a camera tilt decoder, a cross-attention module, and a base trajectory decoder. The LiDAR encoder processes LiDAR input to generate LiDAR tokens, while the reference image encoder and RGB-D encoder process a reference image and RGB-D input, respectively, to generate reference image tokens and RGB-D tokens, respectively. The vision encoder processes the reference image tokens and the RGB-D tokens and generates vision tokens, providing a compact representation of the environment. The context encoder processes a robot size, a look-at pose, the LiDAR tokens, and the vision tokens to generate context tokens, which are further processed by the cross-attention module to generate cross-attention features before passing the features to the base trajectory decoder. The base trajectory decoder generates a sequence of waypoints for the robot movement based on the cross-attention features, while the camera tilt decoder processes context tokens to predict adjustments to the camera tilt to maintain visibility of the target object. Optionally, the target object mask decoder generates object masks that highlight relevant areas in the scene. A robot control application then uses the base trajectory and camera tilt to control the robot movement, positioning robot relative to task-relevant target objects.

In some embodiments, the vision-based robot control model is trained using generated training data from a simulation environment. In order to generate the training data, a scene sampler selects multiple scenes which include different objects, spatial layouts, and/or lighting conditions from scene data. A simulator then uses a robot model and a scene sample to generate an initial robot state and a goal robot state, defining the robot's starting position and target goal. The simulator also generates goal specifications, including a reference image, look-at pose, and a target object mask. A trajectory generator then computes a robot plan, including a collision-free base trajectory and camera tilts, using the robot model, initial state, and goal state. Using the robot plan, the simulator generates multi-modal inputs, such as RGB-D inputs, LiDAR inputs, and robot state data collected along the base trajectory. The multi-modal inputs, along with the goal specifications and robot plan, may be processed by a data augmentation module to improve diversity before being stored into training data. The foregoing process can be repeated any number of times using different scene samples to generate training data. Once the training data is generated, a model trainer trains the vision-based robot control model over multiple training epochs. The model trainer feeds the training data into the vision-based robot control model, which processes the training data and generates robot plans. A loss calculation module compares the generated robot plans to ground truth data in the training dataset and computes a loss. The model trainer then updates one or more parameters of the vision-based robot control model based on the computed loss. The training process iteratively improves the model performance, so that the model can generalize to diverse environments and tasks while reducing errors in predicting base trajectory and camera tilt.

The techniques for training and using a vision-based robot control model described herein have many real-world applications. For example, these techniques could be used to train a vision-based robot control model that enables robots to maneuver to precise positions relative to objects, such as positioning a forklift in front of a pallet for loading, aligning in front of a workstation in a factory, or docking at a charging station in a household or industrial setting. As another example, these techniques could be used to train a vision-based robot control model deployed in autonomous systems, such as delivery robots navigating urban environments to reach specific drop-off locations, inspection robots positioning themselves to capture detailed data on infrastructure, such as pipelines or bridges, or agricultural robots maneuvering to precise positions for tasks, such as spraying or harvesting.

The above examples are not in any way intended to be limiting. As persons skilled in the art will appreciate, as a general matter, the techniques for training and using a vision-based robot control model described herein can be implemented in any suitable application.

### System Overview

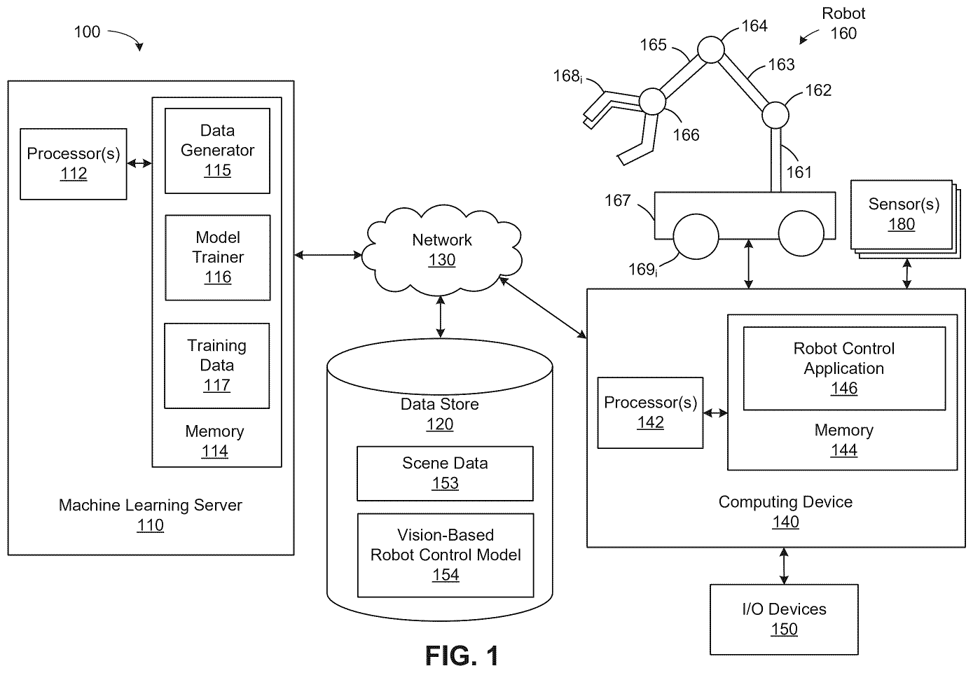

FIG. 1 illustrates a block diagram of a computer-based system 100 configured to implement one or more aspects of at least one embodiment. As shown, system 100 includes a machine learning server 110, a data store 120, and a computing device 140 in communication over a network 130, which can be a wide area network (WAN) such as the Internet, a local area network (LAN), a cellular network, and/or any other suitable network. Machine learning server 110 includes, without limitation, processor(s) 112 and a memory 114. Memory 114 includes, without limitation, a data generator 115, a model trainer 116, and training data 117. Data store 120 includes, without limitation, scene data 153 and a vision-based robot control model 154. Computing device 140 includes, without limitation, processor(s) 142 and a memory 144. Memory 144 includes, without limitation, a robot control application 146.

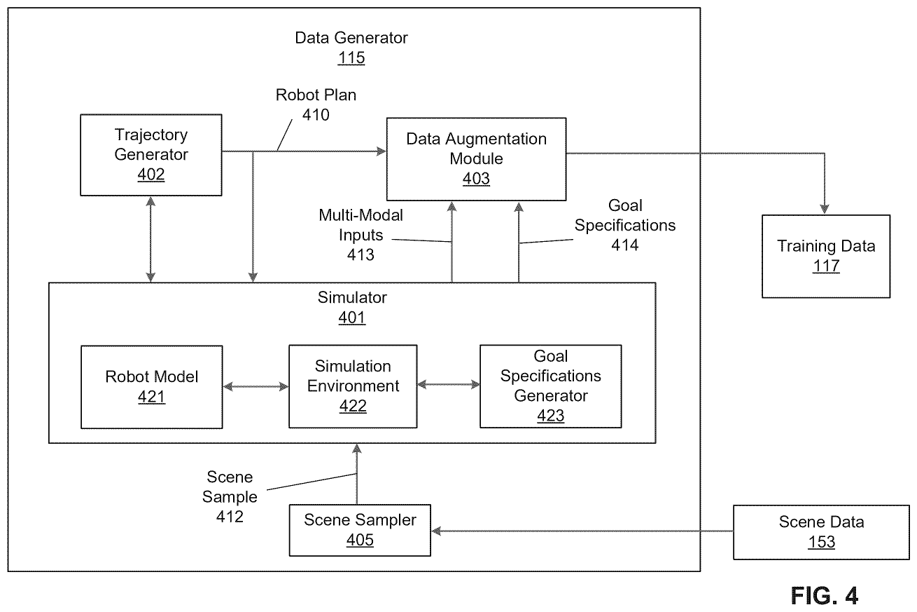

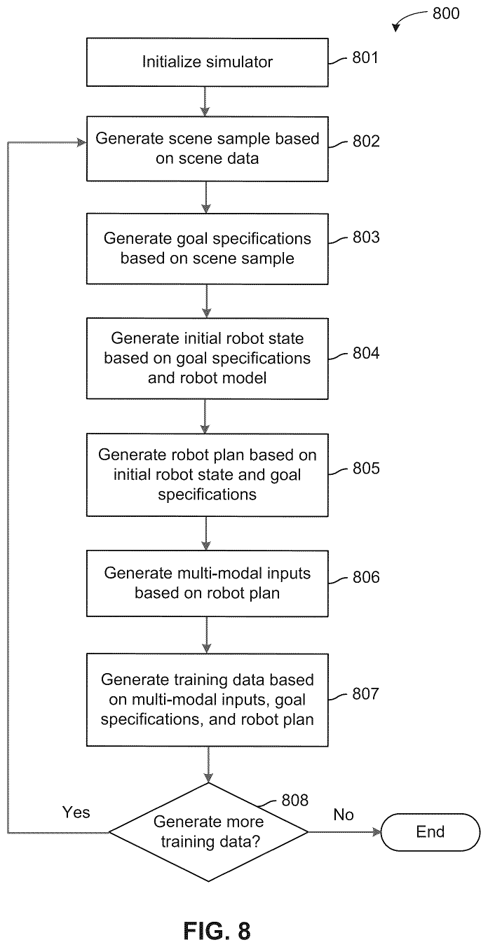

As shown, a data generator 115 executes on one or more processors 112 of machine learning server 110 and is stored in a system memory 114 of machine learning server 110. In various embodiments, data generator115 is an application that uses scene data 153 stored in data store 120 to generate training data 117. Training data 117, which can be stored in memory 114 or elsewhere (e.g., in data store 120), includes various multi-modal inputs, such as RGB-D data, LiDAR data, and goal specifications, along with corresponding outputs, such as robot plans (e.g., base trajectory and camera tilt) and goal specifications. In various embodiments, data generator 115 simulates diverse scenarios using scene data 153, including varying object configurations, environmental layouts, and lighting conditions, to ensure training data 117 is comprehensive and supports generalization across different tasks and robot sizes. Data generator 115 is described in greater detail below in conjunction with FIGS. 4 and 8.

As shown, a model trainer 116 is an application that executes on one or more processors 112 of machine learning server 110 and is stored in a system memory 114 of machine learning server 110. Although shown as distinct from the data generator 115 for illustrative purposes, in some embodiments, functionality of the data generator 115 and the model trainer 116 can be combined into a single application. Processor(s) 112 receive user input from input devices, such as a keyboard or a mouse. In operation, processor(s) 112 may include one or more primary processors of machine learning server 110, controlling and coordinating operations of other system components. In particular, processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

System memory 114 of machine learning server 110 stores content, such as software applications and data, for use by processor(s) 112 and the GPU(s) and/or other processing units. System memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in system memory 114 can be modified as desired. Further, the connection topology between the various units in FIG. 1 can be modified as desired. In some embodiments, any combination of processor(s) 112, system memory 114, and/or GPU(s) can be included in and/or replaced with any type of virtual computing system, distributed computing system, and/or cloud computing environment, such as a public, private, or a hybrid cloud system.

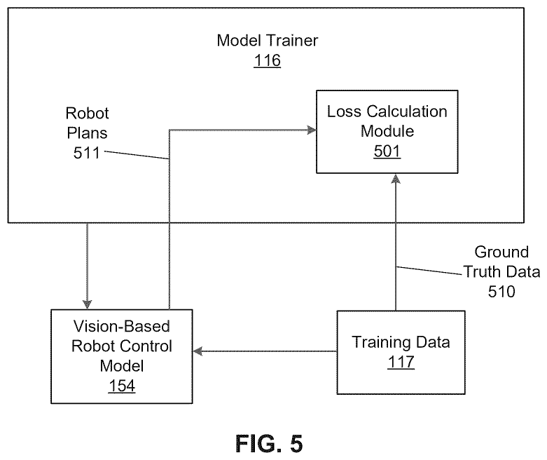

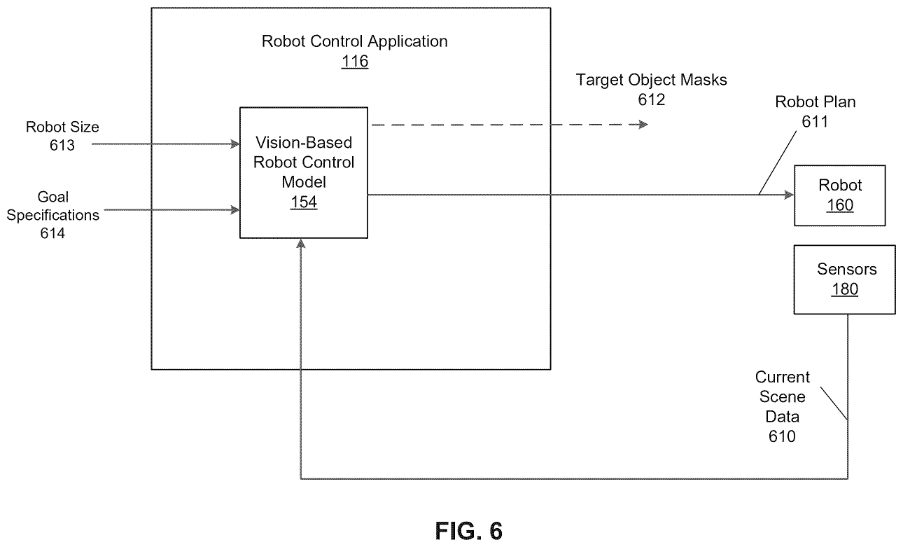

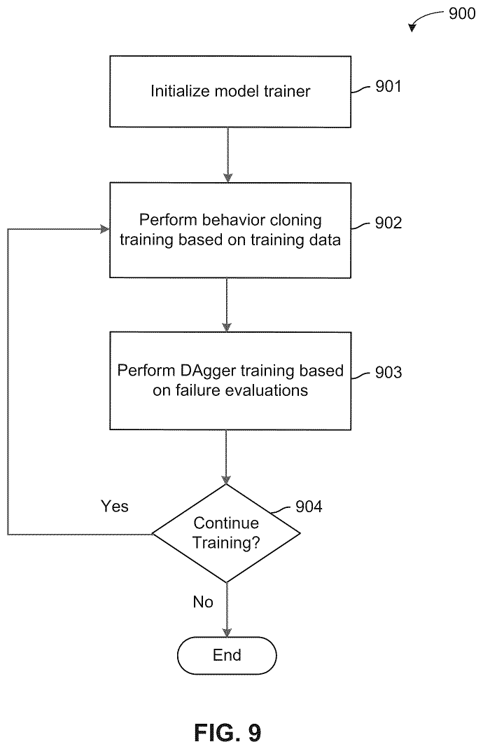

In some embodiments, model trainer 116 is configured to train one or more machine learning models, including a vision-based robot control model 154. Vision-based robot control model 154 is a machine learning model, such as a neural network, which is trained to generate robot plans for a robot (e.g., robot 160) to perform a task based on multi-modal inputs included in a current scene acquired via one or more sensors 180i (referred to herein collectively as sensors 180 and individually as a sensor 180), as discussed in greater detail below in conjunction with FIGS. 6-7 and 10-11. For example, in at least one embodiment, sensors 180 can include one or more cameras, one or more RGB-D cameras (e.g., cameras using time-of-flight sensors), one or more LiDAR sensors, any combination thereof, etc. Techniques for training vision-based robot control model 154 based on training data 117 are discussed in greater detail herein in conjunction with at least FIGS. 5 and 9. Vision-based robot control model 154 can be stored in data store 120. In some embodiments, data store 120 can include any storage device or devices, such as fixed disc drive(s), flash drive(s), optical storage, network attached storage (NAS), and/or a storage area-network (SAN). Although shown as accessible over network 130, in at least one embodiment machine learning server 110 can include data store 120.

As shown, a robot control application 146 that uses trained vision-based robot control model 154 is stored in data store 120 accessed over network 130, and executes on processor(s) 142, of computer device 140. Once trained, trained vision-based control model 154 can be deployed, such as via robot control application 146, to control a physical robot in a real-world environment, such as robot 160. In various embodiments, trained vision-based robot control model 154 is deployed for use with virtual environments, such as in a simulator (not shown), where a virtual model of robot 160 is simulated within a virtual environment, such as a digital twin or a simulation platform. In the virtual deployment, robot control application 146 interfaces with a virtual representation of robot 160 enabling testing, validation, and refinement of robot plans. Memory 144 and the processor(s) 142 can be similar to memory 114 and processor(s) 112 of machine learning server 110, described above. Robot control application 146 is discussed in greater detail below in conjunction with FIG. 6.

As shown, robot 160 includes multiple links 161, 163, and 165 that are rigid members, as well as joints 162, 164, and 166 that are movable components that can be actuated to cause relative motion between adjacent links. In addition, robot 160 includes multiple fingers 168i (referred to herein collectively as fingers 168 and individually as a finger 168) that can be controlled to grip an object. For example, in at least one embodiment, robot 160 can include a locked wrist and multiple (e.g., four) fingers. In some examples, robot 160 has camera and LiDAR sensors 180, such as a tilt-enabled forward RGB-D camera at 1.5 m high and a 2D LiDAR mounted on the base, providing 360 degrees coverage. Robot 160 further includes a mobile base 167 that provides robot 160 with locomotion capabilities. Mobile base 167 is equipped with multiple wheels 169ᵢ (referred to herein collectively as wheels 169 and individually as a wheel 169), enabling robot 160 to navigate various environments, such as warehouses, homes, outdoor settings, and/or the like. In some embodiments, mobile base 167 supports differential drive, which allows robot 160 to maneuver using independent control of the left and right wheels 169. Each wheel 169 can be independently actuated, providing precise motion control for tasks such as turning in place, following complex trajectories, or navigating uneven surfaces. In some examples, the wheels are designed to bear the weight of robot 160 while maintaining stability and enabling smooth movement over various types of terrain. In some embodiments, robot 160 includes a mobile base 167 equipped with tracks instead of wheels 169, allowing robot 160 to navigate challenging terrains, such as uneven or soft surfaces. Although an example robot 160 is shown for illustrative purposes, in at least one embodiment, techniques disclosed herein can be applied to control any suitable robot.

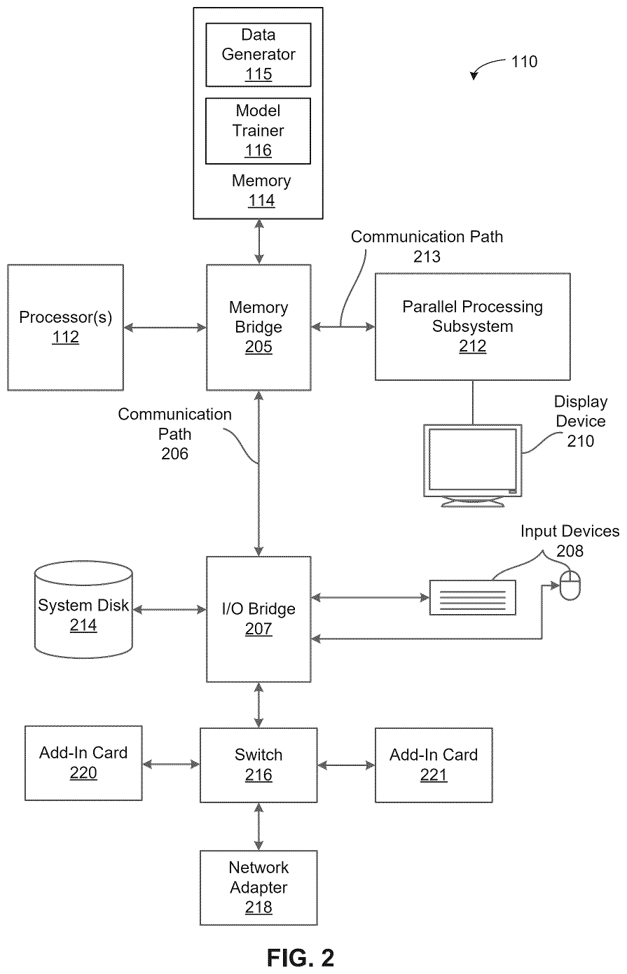

FIG. 2 is a block diagram illustrating machine learning server 110 of FIG. 1 in greater detail, according to various embodiments. Machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, machine learning server 110 is a server machine operating in a data center or a cloud computing environment that provides scalable computing resources as a service over a network.

In various embodiments, machine learning server 110 includes, without limitation, processor(s) 112 and memory (ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to processor(s) 112 for processing. In some embodiments, machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via network adapter 218. In some embodiments, switch 216 is configured to provide connections between I/O bridge 207 and other components of machine learning server 110, such as a network adapter 218 and various add-in cards 220 and 221.

In some embodiments, I/O bridge 207 is coupled to a system disk 214 that may be configured to store content and applications and data for use by processor(s) 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, parallel processing subsystem 212 may incorporate circuitry optimized for graphics and video processing, including, for example, video output circuitry. Such circuitry may be incorporated across one or more parallel processing units (PPUs), also referred to herein as parallel processors, included within parallel processing subsystem 212.

In some embodiments, parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, system memory 114 includes, without limitation, data generator 115 and model trainer 116. Although described herein primarily with respect to data generator 115 and model trainer 116, techniques disclosed herein can also be implemented, either entirely or in part, in other software and/or hardware, such as in parallel processing subsystem 212.

In various embodiments, parallel processing subsystem 212 may be integrated with one or more of the other elements of FIG. 2 to form a single system. For example, parallel processing subsystem 212 may be integrated with processor 142 and other connection circuitry on a single chip to form a system on a chip (SoC).

In some embodiments, processor(s) 112 includes the primary processor of machine learning server 110, controlling and coordinating operations of other system components. In some embodiments, processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

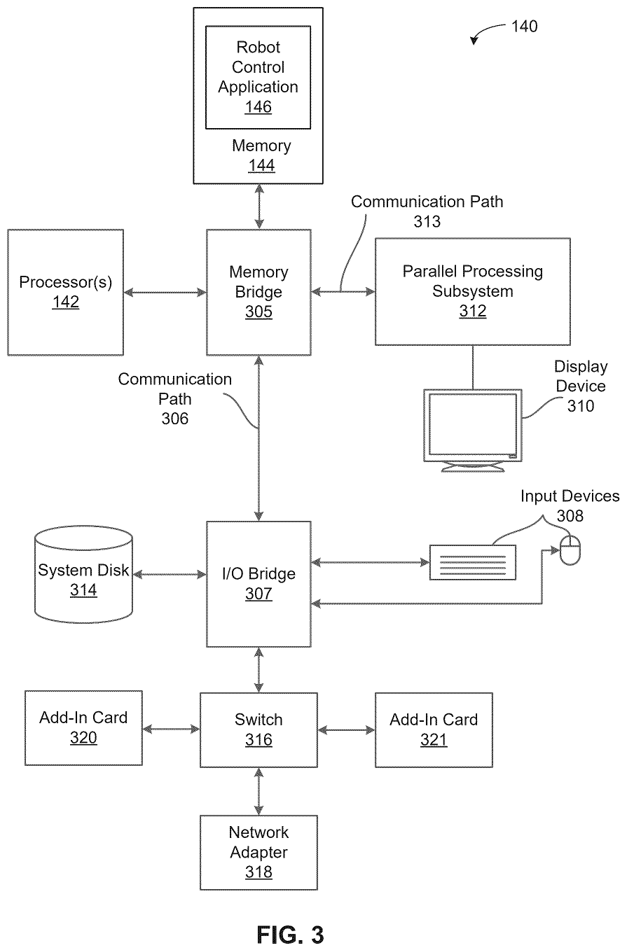

FIG. 3 is a block diagram illustrating computing device 140 of FIG. 1 in greater detail, according to various embodiments. Computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network. In some embodiments, machine learning server 110 can include one or more similar components as computing device 140.

In various embodiments, computing device 140 includes, without limitation, processor(s) 142 and memory (ies) 144 coupled to a parallel processing subsystem 312 via a memory bridge 305 and a communication path 313. Memory bridge 305 is further coupled to an I/O (input/output) bridge 307 via a communication path 306, and I/O bridge 307 is, in turn, coupled to a switch 316.

In one embodiment, I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to processor(s) 142 for processing. In some embodiments, computing device 140 may be a server machine in a cloud computing environment. In such embodiments, computing device 140 may not include input devices 308, but may receive equivalent input information by receiving commands (e.g., responsive to one or more inputs from a remote computing device) in the form of messages transmitted over a network and received via network adapter 318. In some embodiments, switch 316 is configured to provide connections between I/O bridge 307 and other components of computing device 140, such as a network adapter 318 and various add-in cards 320 and 321.

In some embodiments, I/O bridge 307 is coupled to a system disk 314 that may be configured to store content and applications and data for use by processor(s) 142 and parallel processing subsystem 312. In one embodiment, system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 307 as well.

In various embodiments, memory bridge 305 may be a Northbridge chip, and I/O bridge 307 may be a Southbridge chip. In addition, communication paths 306 and 313, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 312 comprises a graphics subsystem that delivers pixels to an optional display device 310 that may be any conventional cathode ray tube, liquid crystal display, light-emitting diode display, and/or the like. In such embodiments, parallel processing subsystem 312 may incorporate circuitry optimized for graphics and video processing, including, for example, video output circuitry. Such circuitry may be incorporated across one or more parallel processing units (PPUs), also referred to herein as parallel processors, included within parallel processing subsystem 312.

In some embodiments, parallel processing subsystem 312 incorporates circuitry optimized (e.g., that undergoes optimization) for general purpose and/or compute processing. Again, such circuitry may be incorporated across one or more PPUs included within parallel processing subsystem 312 that are configured to perform such general purpose and/or compute operations. In yet other embodiments, the one or more PPUs included within parallel processing subsystem 312 may be configured to perform graphics processing, general purpose processing, and/or compute processing operations. System memory 144 includes at least one device driver configured to manage the processing operations of the one or more PPUs within parallel processing subsystem 312. In addition, system memory 144 includes robot control application 146. Although described herein primarily with respect to robot control application 146, techniques disclosed herein can also be implemented, either entirely or in part, in other software and/or hardware, such as in parallel processing subsystem 312.

In various embodiments, parallel processing subsystem 312 may be integrated with one or more of the other elements of FIG. 3 to form a single system. For example, parallel processing subsystem 312 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, processor(s) 142 issue commands that control the operation of PPUs. In some embodiments, communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 302, and the number of parallel processing subsystems 312, may be modified as desired. For example, in some embodiments, system memory 144 could be connected to processor(s) 142 directly rather than through memory bridge 305, and other devices may communicate with system memory 144 via memory bridge 305 and processor 142. In other embodiments, parallel processing subsystem 312 may be connected to I/O bridge 307 or directly to processor 142, rather than to memory bridge 305. In still other embodiments, I/O bridge 307 and memory bridge 305 may be integrated into a single chip instead of existing as one or more discrete devices. In certain embodiments, one or more components shown in FIG. 3 may not be present. For example, switch 316 could be eliminated, and network adapter 318 and add-in cards 320, 321 would connect directly to I/O bridge 307. Lastly, in certain embodiments, one or more components shown in FIG. 3 may be implemented as virtualized resources in a virtual computing environment, such as a cloud computing environment. In particular, parallel processing subsystem 312 may be implemented as a virtualized parallel processing subsystem in at least one embodiment. For example, parallel processing subsystem 312 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Training Data Generation Using Scene Data

FIG. 4 is a more detailed illustration of data generator 115, according to various embodiments. As shown, data generator 115 includes, without limitation, a simulator 401, a trajectory generator 402, a data augmentation module 403, and a scene sampler 405. Simulator 401 includes, without limitation, a robot model 421, a simulation environment 422, and a goal mask generator 423. In operation, scene sampler 405 processes scene data 153 and generates a scene sample 412. Simulator 401 processes scene sample 412, interacts with trajectory generator 402, and generates multi-modal inputs 413 and goal specifications 414. In various embodiments, simulator 401 uses robot model 421 to simulate the physical behavior of robot 160, simulation environment 422 to create a virtual space for a virtual representation of robot 160 to operate, and goal mask generator 423 to identify and highlight target objects or regions in the scene sample 412. Trajectory generator 402 generates robot plan 410, which includes a collision-free base trajectory and camera tilt, based on the robot initial state, the goal state, and the environment defined by the simulator 401. Data augmentation module 403 processes robot plan 410, multi-modal inputs 413, and goal specifications 414 and generates training data 117.

As described, scene sampler 405 processes scene data 153 and generates scene sample 412. Scene data 153 includes information about the virtual environment, such as object models, spatial layouts, textures, lighting conditions, and/or the like. Scene data 153 also includes predefined scenarios or parameters for generating diverse environments, such as obstacle configurations, target object placements, and environmental variations, such as noise, occlusions, and/or the like. In some examples, the habitat synthetic scenes dataset (HSSD), which includes diverse and highly detailed virtual spaces, such as kitchens, living rooms, and offices, can be used as scene data 153. For example, the spaces can be populated with distinct objects, including chairs, tables, cabinets, shelves, and miscellaneous items, such as kitchen utensils and decorative objects. Scene sampler 405 processes scene data 153 and generates scene sample 412 tailored to various tasks. For example, scene sampler 405 can position objects in random or structured layouts to simulate pick-and-place tasks, add obstacles in various arrangements to simulate navigation tasks, introduce lighting and texture changes to simulate different operating environments, and/or the like. Scene sample 412 is a representation of the operating environment of robot 160 at a particular point in time, including the spatial arrangement of objects and any environmental features, such as obstacles or lighting conditions. For example, scene sample 153 can include a room with furniture arranged in a specific layout, a designated target object placed on a table, and obstacles scattered throughout the space. Using the foregoing approach, scene sampler 405 can generate a set of scene samples that includes multiple scene samples in some embodiments.

Simulator 401 processes scene sample 412, interacts with trajectory generator 402, and generates multi-modal inputs 413 and goal specifications 414. Multi-modal inputs 413 include data collected along a planned trajectory of robot 160 (e.g., robot plan 410), such as RGB-D inputs (e.g., RGB-D images) capturing the perspective of robot 160, LiDAR inputs (e.g., LiDAR scans) providing depth and spatial information, and robot state data that includes, without limitation, the position, velocity, and orientation of robot 160 at each point in the planned trajectory. Goal specifications 414 define the target object or region that robot 160 has to interact with or reach. In various embodiments, due to the lack of a full 3D model or map, goal specifications 414 G is derived from a reference image I_{R} and includes the target object mask M, which highlights the object of interest. Any suitable goal specifications 414 can be used in some embodiments. For example, in some embodiments, goal specifications 414 assume that common objects have four dominant sides (e.g., front, back, left, right), described by the object bounding box. The most visible side in the reference image can be denoted as the “front,” and the look-at pose is defined as C={S, d, θ}, where S represents the approach side (e.g., front, back, left, right), d is the approach distance, and θ is the approach angle. Together, the goal specification can be defined as G={I_{R}, M, C}, which provides instructions for reaching and interacting with the target object.

As shown, simulator 401 includes, without limitation, robot model 421, simulation environment 422, and goal specifications generator 423. Robot model 421 models the physical and dynamic properties of robot 160. In some embodiments, robot model 421 is a differential-drive robot model. The differential-drive robot model can be adapted to other kinematics, such as omnidirectional robots, Ackermann-steering robots, and/or the like, through fine-tuning or additional tracking controllers. In some examples, robot 160 is modeled as a cylindrical rigid body with a radius R, enabling simplified calculations for collision detection and trajectory planning. Simulation environment 422 creates a virtual space that replicates real-world conditions for the operation of robot 160. In various embodiments, simulation environment 422 includes spatial layouts, obstacle configurations, and environmental features such as textures, lighting conditions, and dynamic elements. For example, simulation environment 422 can include a cluttered warehouse layout for navigation tasks or a tabletop setting with objects for manipulation tasks. Goal specifications generator 423 generates goal specifications 414 G. In some embodiments, goal specifications generator 423 generates semantic masks or binary masks that localize the target object in a scene. For example, in a navigation task, the goal mask M can define a region robot 160 has to reach, such as a doorway or a docking station. In a manipulation task, the goal mask M can outline the specific part of an object that the end effector of robot 160 should grasp. In various embodiments, simulator 401 generates a reference image I_{R} based on the initial camera view of robot 160 or from a random camera view in the environment, providing a visual context for the task. Goal specifications generator 423 then generates target object mask M randomly from I_{R}, excluding non-objects such as walls and floors. Additionally, goal specifications generator 423 samples a look-at pose C by selecting a side S (e.g., front, back, left, or right), a distance d within a range (e.g., [0.1 m, 0.5 m]), and an angle θ from a set of predefined values (e.g., {0°, ±15°, ±30°}). Simulator 401 then places robot 160 in simulation environment 422 at the goal position and performs collision checks to ensure a feasible configuration. In various embodiments, simulator 401 selects a random initial robot state based on goal specifications 414 and robot model 421. For example, simulator 401 can randomly place robot 160 in the traversable area of a virtual room while ensuring that an orientation of robot 160 allows robot 160 to eventually approach the target object or region specified in goal specifications 414. If the task involves reaching the right side of a target object within 0.7 meters at an angle of 0°, simulator 401 can initialize robot 160 at a location that needs navigating around obstacles or taking a direct path toward the specified target. In some embodiments, simulator 401 also takes into account the constraints and dynamics of robot model 421, such as kinematic limitations and movement capabilities. For example, for a differential-drive robot, simulator 401 could avoid initializing robot 160 in configurations that would require sharp turns exceeding robot physical constraints.

Trajectory generator 402 interacts with simulator 401 and generates robot plan 410. In various embodiments, trajectory generator 402 uses robot model 421 to compute collision-free base trajectory within simulated environment 422. In some examples, in order to design a base trajectory for robot 160, trajectory generator 402 uses a sampling-based algorithm, such as the Asymptotically Optimal Incremental Tree-based planner (AIT*) in the Reeds-Shepp state space, configured with a fixed turning radius (e.g., 0) to allow flexible trajectory generation for differential-drive robots. In various embodiments, trajectory generator 402 is adaptable and can design the base trajectory for other robot kinematics by altering the state space and related constraints. In various embodiments, trajectory generator 402 uses a cost function during the design of the base trajectory that encourages robot 160 to maintain forward motion and minimize excessive backward movement. In some examples, trajectory generator 402 allows a base trajectory with small backward motions whenever the base trajectory results in a faster route to the goal. In various embodiments, for each feasible base trajectory, trajectory generator 402 also renders camera observations along the path, maintaining a fixed distance gap (e.g., 0.2 meters) or an angular gap (e.g., 5 degrees) between successive observations. Trajectory generator 402 adjusts camera tilt such that the lowest vertex of the target object's mesh appears at a fixed position (e.g., ¼) above the bottom of the image, ensuring consistent visibility and alignment with the goal, even when the object is out of view. Trajectory generator 410 then generates robot plan 410, which includes collision-free base trajectory and camera tilt.

Simulator 401 uses robot plan 410 to generate multi-modal inputs 413. In various embodiments, simulator 401 simulates RGB-D inputs and LiDAR inputs along the base trajectory included in robot plan 410, as well as robot state data. In some embodiments, to generate RGB-D inputs, simulator 401 uses simulation tools, such as NVIDIA Isaac Sim®, which provides photorealistic rendering and accurate depth estimation. The RGB component is rendered using one or more virtual cameras placed at the viewpoint of robot 160, capturing high-resolution images of the scene. The depth component is calculated based on the simulated distances from the camera(s) to objects in the simulation environment 422, creating a depth map that corresponds to the perspective of robot 160. LiDAR inputs are simulated by emitting virtual laser beams from LiDAR sensor model(s) and measuring the simulated distances to objects and surfaces within simulation environment 422. The LiDAR scans are processed to generate point clouds that provide precise spatial data, including the shapes, positions, and distances of obstacles and objects in the surroundings of robot 160. In various embodiments, simulator 401 accounts for environmental factors, such as lighting, occlusions, and reflective surfaces, to ensure the LiDAR inputs are realistic and representative of real-world conditions. Robot state data is computed based on the robot kinematic model included in robot model 421 and the base trajectory included in robot plan 410. Simulator 401 updates the state of robot 160 dynamically as robot 160 moves along the base trajectory, ensuring accurate and consistent representation of the robot motion.

Data augmentation module 403 processes robot plan 410, multi-modal inputs 413, and goal specifications 414 and generates training data 117. Data augmentation module 403 applies various transformations to enhance the diversity and robustness of training data 117, helping to ensure that vision-based robot control model 154 can generalize across various real-world scenarios. For example, data augmentation module 403 can introduce variations in lighting, object textures, and environmental noise to simulate different operating conditions. Data augmentation module 403 can also adjust the RGB-D inputs by altering camera angles, cropping, or resizing images to account for different robot configurations and viewpoints. Additionally, data augmentation module 403 can modify LiDAR inputs by adding noise or simulating sensor occlusions to mimic challenging conditions, such as cluttered environments, poor visibility, and/or the like. In some embodiments, data augmentation module 403 augments the robot state data by slightly perturbing positions or velocities to provide a broader distribution of possible base trajectories. In various embodiments, data augmentation module 403 augments the target object mask data and goal specifications by varying target object placements, approach angles, and distances to reflect diverse task requirements.

### Training a Vision-Based Robot Control Model Using Training Data

FIG. 5 is a more detailed illustration of the model trainer 116, according to various embodiments. As shown, model trainer 116 includes a loss calculation module 501.

In operation, model trainer 116 initializes one or more parameters of vision-based robot control model 154 randomly or using initialization techniques, such as Xavier or He initialization, depending on the activation functions and architecture of vision-based robot control model 154. Xavier initialization can be used when the model employs symmetric activation functions, such as sigmoid or tanh, ensuring that the variance of inputs and outputs is preserved throughout the layers. He initialization can be applied when vision-based robot control model 154 uses rectified linear units (ReLU) or variants of, allowing for better handling of the gradient flow during training. In some embodiments, during initialization, model trainer 116 assigns weights to each layer of vision-based robot control model 154, drawing from a normal or uniform distribution scaled based on the number of input and output neurons for each layer. At every training epoch, vision-based robot control model 154 processes training data 117 and generates robot plans 511, which includes a base trajectory, a camera tilt, and optionally a target object mask

Loss calculation module 501 processes ground truth data 510, which includes ground truth robot plans, and robot plans 511, generated by vision-based robot control model 154, and computes a loss. In some embodiments, loss calculation module 501 computes a loss L, which includes three components: Lₘₐₛₖ, L_{base}, and Lₜᵢₗₜ. The term Lₘₐₛₖ (e.g., target object mask loss) is a pixel-wise L2 loss that regresses thetarget object masks in all history frames, so that vision-based robot control model 154 accurately locates the target object in each frame. In some examples, Lₘₐₛₖ is computed as:

$${L}_{m a s k} = {\sum }_{i = 1}^{H} {\sum }_{x , y} {( {M}_{i} ( x , y ) - {M}_{i}^{*} ( x , y ) )}^{2} , \qquad ( Equation 1 )$$

where i is the frame index, x, y are the pixel coordinates, Mᵢ is the predicted target object mask included in robot plans 511, and Ma is the ground truth mask included in ground truth data 510. The term L_{base} (e.g., base trajectory loss) includes both a classification loss and a regression loss for each waypoint of the base trajectory included in robot plans 511, where the classification loss handles discrete waypoint categories or classes along the base trajectory. Waypoints can represent distinct motion decisions or actions, such as moving forward, turning left, turning right, or stopping. Each of the actions can be treated as a discrete category that vision-based robot control model 154 needs to classify correctly based on multi-modal inputs 413 included in training data 117. The regression loss refines continuous trajectory parameters, such as the exact direction, distance, and heading angle of robot 160 at each step along the base trajectory. For example, in a waypoint where robot 160 needs to turn, the regression loss ensures that the predicted turning angle (e.g., 15°) closely matches the ground truth turning angle included in ground truth data 510. For waypoints that involve moving forward, the regression loss ensures that the predicted distance (e.g., 0.5 meters) and heading adjustments are as close as possible to the ground truth values included in ground truth data 510. In some examples, the base trajectory loss is given by:

$${L}_{b a s e} = {\sum }_{i = 1}^{T} C r o s sEntropy ( {logits}_{{ψ}_{i}} , {bin}_{{ψ}_{i}} ) + {\sum }_{i = 1}^{T} {( {δ}_{{ψ}_{i}} , {δ}_{{ψ}_{i}}^{*} )}^{2} + {\sum }_{i = 1}^{T} C r o s s E n t r opy ( {logits}_{{r}_{i}} , {bin}_{{r}_{i}} ) + {\sum }_{i = 1}^{T} {( {δ}_{{r}_{i}} , {δ}_{{r}_{i}}^{*} )}^{2} + {\sum }_{i = 1}^{T} ( {logits}_{{ϕ}_{i}} , {bin}_{{ϕ}_{i}} ) + {\sum }_{i = 1}^{T} {( {δ}_{{ϕ}_{i}} , {δ}_{{ϕ}_{i}}^{*} )}^{2} , \qquad ( Equation 2 )$$

where ap is direction, r is distance, Φ is heading, and bin and δ* are the ground truth bin indices and residuals. A bin refers to the discrete category assigned to a waypoint parameter (e.g., directionΨ, distance r, or heading Φ) after discretizing the continuous value space into a fixed number of intervals. Each bin represents a specific range of values, and vision-based robot control model 154 predicts the most likely bin for a given waypoint parameter. logits refer to the unnormalized outputs of the one or more neural networks included in vision-based robot control model 154 before applying a softmax function, representing the prediction confidence in assigning a given waypoint parameter (e.g., direction Ψ, distance r, or heading Φ) to a discrete bin. The term Lₜᵢₗₜ (e.g., camera tilt loss) is an L2 loss that regresses the camera tilt, ensuring proper alignment of the camera field of view with the target object. In some examples, the camera tilt loss is given by:

$${L}_{t i l t} = {( α - {α}^{*} )}^{2} , \qquad ( Equation 3 )$$

where α and α* are the predicted camera tilt included in robot plan 511 and the ground truth camera tilt included in ground truth data 510 for the current observation, respectively.

Model trainer 116 then updates one or more parameters of vision-based robot control model 154 based on the loss. The update process is performed using an optimization algorithm, such as stochastic gradient descent (SGD) or one of the variants of SGD, such as Adaptive Moment Estimation (Adam) or Root Mean Square Propagation (RMSprop). In some examples, model trainer 116 trains vision-based robot control model 154 over a number (e.g., 150000) of training epochs with batch sizes of, e.g., 128 of multi-modal inputs 413, goal specifications 414, and ground truth data 510 included in training data 117. The training begins with a behavior cloning phase, where model trainer 116 trains vision-based robot control model 154 to imitate expert demonstrations from training data 117. After the behavior cloning phase, model trainer 116 tests vision-based robot control model 154 in simulation to identify potential failures, such as collisions, tracking losses, or deviations from the desired base trajectory included in ground truth data 510. In some embodiments, the failures can be addressed by augmenting training data 117 using the Dataset Aggregation (DAgger) technique. In some embodiments, model trainer 116 uses the DAgger technique to generate more training data that includes failure cases. In various embodiments, vision-based robot control model 154 includes various encoders, such as a look-at-pose encoder, robot size encoder, a LiDAR encoder, a reference image encoder, an RGB-D encoder, a vision encoder, and/or the like, which may be fixed during training or pre-trained on relevant datasets. In various embodiments, during training, model trainer 116 randomly selects a base trajectory included in training data 117 and an observation index i to generate one training sample. In some examples, training data 117 includes reference image I_{R}, target object mask M, past RGB-D inputs Iᵢ, . . . , I_{i-H+1}, current LiDAR inputs x₁, y₁, . . . , x₂₅₆, y₂₅₆, odometry odom i, . . . , odom_{i-H1+1}, which is used to transform the depth into the current camera base frame, robot radius R (e.g., robot size), and goal conditions S, d, θ, and S is parametrized with a 4-element onehot vector. In such cases, the ground truth waypoints included in the base trajectory and camera tilt can be computed at observation index i, where the number of waypoints and the discretization of the waypoints can be adjusted. In some embodiments, model trainer 116 trains vision-based robot control model 154 according to Algorithm 1:

### Algorithm 1

Sample a batch of training samples from training data 117, such as a batch size of 128;
Generate predictions using vision-based robot control model 154, such as target object masks Mᵢ, . . . , M_{i-H+1}, waypoints Ψ₁, r₁, Φ₁, r₂, Φ₂, . . . , Ψ_{T}, r_{T}, Φ_{T} included in base trajectory, camera tilt a;
Compute the loss and do the backward pass to compute the gradients;
Update one or more parameters of vision-based robot control model 154;
Repeat.

In various embodiments, model trainer 116 decides to stop training based on one or more convergence criteria to ensure vision-based robot control model 154 has learned the task without overfitting to training data 117. In such cases, the criteria can include monitoring the loss during training and stopping when the total loss L stabilizes or falls below a predefined threshold, indicating that further training is unlikely to yield significant improvements. Additionally, model trainer 116 evaluates the performance of vision-based robot control model 154 on a validation dataset that is separate from training data 117. If the validation loss stops decreasing or begins to increase, model trainer 116 infers overfitting and model trainer 116 stop training. In some embodiments, early stopping techniques are used, where training halts if no improvement in validation performance is observed for a specified number of epochs. Model trainer 116 can use other techniques to stop training. For example, model trainer 116 can monitor specific metrics, such as trajectory accuracy, collision rate, or task completion success rate, to ensure vision-based robot control model 154 meets predefined performance benchmarks before ending the training process.

### Robot Control Using Vision-Based Robot Control Model

FIG. 6 is a more detailed illustration of the robot control application 116, according to various embodiments. As shown, robot control application 116 uses the trained vision-based robot control model 154 to process robot size 613, goal specifications 614, and current scene data 610 and generate robot plan 611 and optionally target object masks 612.

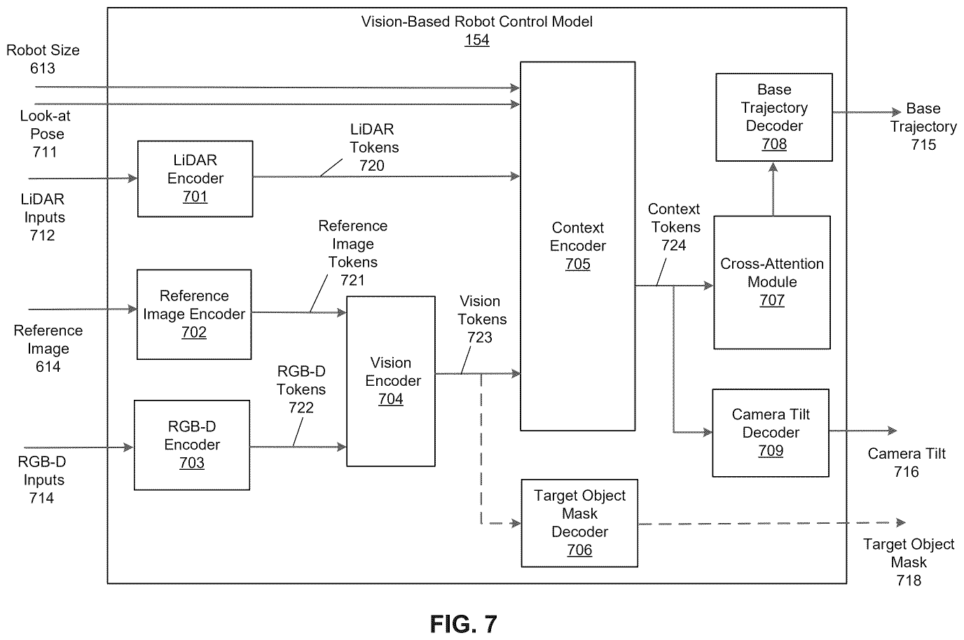

Robot control application 116 uses the trained vision-based robot control model 154 to process robot size 613, goal specifications 614, and current scene data 610 obtained by sensors 180 and generate robot plan 611 to control robot 160 and optionally generate target object masks 612. Robot size 613 represents the physical dimensions of robot 160, such as width, height, length, and/or radius R (e.g., footprint), which are used to ensure the generated base trajectory included in robot plan 611 are collision-free and feasible within the environment. In some embodiments, goal specifications 614 can be given via I/O devices 150 in terms of natural language or text prompts that describe the task or desired robot behavior. For example, a user can input a command such as “Go to the right side of the table and stand 0.74 meters away” or “Approach the cabinet's front face at 30° from the right side and stand 0.84 meters away.” Robot control application 116 interprets the prompts using various natural language processing (NLP) techniques and translates the prompts into structured goal specifications 614, such as the approach side(S), approach distance (d), and approach angle (θ), as well as generating target object masks M. Current scene data 610 includes sensor observations captured by sensors 180, which include RGB-D inputs and LiDAR inputs, as well as robot state data. In some embodiments, current scene data 610 includes a history of sensor observations over a fixed horizon H. In various embodiments, robot control application 116 uses the trained vision-based robot control model 154 to optionally generate target object masks 612. Target object masks 612 can be binary or semantic masks. In a binary mask, white regions correspond to the target object, and the black region represents the background or non-relevant areas. Target object masks 612 provide a delineation of the target object's boundaries within the current field of view of robot 160. Target object masks 612 can be used to guide the robot actions, such as positioning the end effector precisely for object manipulation or navigating toward the target object while avoiding obstacles. In various embodiments, the trained vision-based robot control model 154 generates base trajectory and camera tilt at different frequencies to optimize robot control. For the base trajectory, the trained vision-based robot control model 154 operates in a receding-horizon fashion: the model generates a base trajectory for up to a fixed T number of steps, which robot 160 follows. After executing T steps, the model generates a new base trajectory based on updated observations included in current scene data 610. For camera tilt, the model generates a new value at every time step, ensuring the camera remains aligned with the target object or area of interest throughout the operation of robot 160. In various embodiments, robot control application 116 continuously monitors whether robot 160 has reached the goal specified in goal specifications 614. In some embodiments, the criterion for determining goal completion is based on evaluating the cumulative change in position and heading between sequential waypoints in the generated trajectory included in robot plan 611. In some examples, robot control application 116 determines that robot 160 has reached the goal when the total Euclidean distance between all sequential waypoints in the trajectory is less than a threshold (e.g., 0.05 m), and the total absolute change in heading between sequential waypoints is less than a threshold (e.g., 2.5 degrees). The criterion permits that the generated plan has converged to a single point, meaning that robot 160 has reached the goal position with the required precision. If the goal completion criteria are met, robot control application 116 stops generating new base trajectories and maintains the final pose of robot 160. If the goal has not been reached, robot control application 116 continues generating updated base trajectories based on current scene data 610 to further refine the movement of robot 160. Vision-based robot control model 154 is described in greater detail below in conjunction with FIG. 7.

FIG. 7 is a more detailed illustration of the vision-based robot control model 154, according to various embodiments. Vision-based robot control model 154 processes look-at pose 711 and reference image 614 included in goal specifications 614, robot size 613, LiDAR inputs 712 and RGB-D inputs 714 included in current scene data 610 and generates base trajectory 715 and camera tilt 716 included in robot plan 611 and optionally a target object mass 718. As shown, vision-based robot control model 154 includes a LiDAR encoder 701, a reference image encoder 702, an RGB-D encoder 703, a vision encoder 704, a context encoder 705, a target object mask decoder 706, a camera tilt decoder 709, a cross-attention module 707, and a base trajectory decoder 708. LiDAR encoder 701 processes LiDAR inputs 712 to generate LIDAR tokens 720. Reference image encoder 702 processes reference image 614 and generates reference image tokens 721. RGB-D encoder 703 processes RGB-D inputs 714 and generates RGB-D tokens 722. Vision encoder 704 processes reference image tokens 721 and RGB-D tokens 722 and generates vision tokens 723. Optionally, target object mask decoder 706 processes vision tokens 723 and generates target object mask 718. Context encoder 705 processes robot size 613, look-at pose 711, LiDAR tokens 720, and vision tokens 723 and generates context tokens 724. Camera tilt decoder 709 processes context tokens 724 and generates camera tilt 716. Cross-attention module 707 processes context tokens 724 and generates cross-attention features. Base trajectory decoder 708 processes cross-attention features and generates base trajectory 715.

As described, LiDAR encoder 701 processes LiDAR inputs 712 and generates LiDAR tokens 720. LiDAR inputs 712 include point cloud data captured by the LiDAR sensors included in sensors 180, such as 2D LiDAR, which provide precise 360-degrees spatial information about the surrounding environment, including object shapes, positions, and distances to obstacles. In various embodiments, LiDAR encoder 701 resamples the LiDAR points to a fixed number, such as 256 points, to ensure uniformity in the input data. The points are then grouped into a fixed number of directional bins (e.g., 32) based on the spatial distribution, with each bin containing a subset of points (e.g., 8 points) represented by the corresponding (x, y) coordinates. Within each bin, LiDAR encoder 701 processes the grouped points using a neural network, such as a Multi-Layer Perceptron (MLP), which extracts high-level features and compresses the data into a single LiDAR token per bin. As a result, LiDAR encoder 701 generates a total fixed number of LiDAR tokens 720 (e.g., 32), each representing the spatial features of a specific directional segment of the environment.

RGB-D encoder 703 processes RGB-D inputs 714 and generates RGB-D tokens 722. RGB-D inputs 714 include RGB images and depth maps captured by the sensors 180, providing both visual and depth information about the scene. The RGB component of RGB-D inputs 714 It (e.g., a 224×224×3 image) is passed through a frozen Masked Autoencoder (MAE-Base) to extract a fixed size feature map (e.g., a 14×14×512 feature map), reducing the image size while preserving key features. The depth component of RGB-D inputs 714 is resized to match the resolution of the RGB feature map (e.g., 14×14) and is used to compute the spatial location of each depth pixel in the egocentric coordinate frame of robot 160. In various embodiments, RGB-D encoder 703 uses the transformation

$$[ {x}^{′} , {y}^{′} , {z}^{′} ] = R {{K}^{- 1} [ x , y , d ]}^{T} + t , \qquad ( Equation 4 )$$

where K is the camera intrinsics and [R|t] is the camera extrinsics, to calculate the 3D spatial position of each depth pixel in meters. For example, a pixel at depth d=2.0 m and screen coordinates x=100, y=150 can be transformed into a 3D coordinate x′=0.5, y′=1.2, z′=2.0. Sinusoidal position embeddings f (x′), f (y′), f (z′) are then computed for the coordinates and concatenated with the corresponding RGB feature patches, incorporating depth information into the visual tokens. In various embodiments, RGB-D encoder 703 also uses camera extrinsics [R|t], derived from the odometry of robot 160, to account for the position and orientation of robot 160 over time. For example, if the camera has rotated by 15° between time steps, the rotation is integrated into the positional encoding. Compared to creating separate depth tokens, encoding depth as positional information ensures the number of visual tokens remains constant (e.g., 196 tokens for a 14×14 feature map).

Reference image encoder 702 processes reference image 614 and generates reference image tokens 721. Reference image 614 is tokenized using the same frozen MAE used for RGB inputs 714. Specifically, reference image 614, which represents a visual snapshot of the target object or area in the environment, is resized (e.g., to 224×224 pixels) and passed through the MAE to extract a fixed size feature map (e.g., a 14×14×512 feature map) included in reference image tokens 721. In some embodiments, target object mask M is also encoded by a shallow convolutional network.

Vision encoder 704 processes reference image tokens721 and RGB-D tokens 722 and generates vision tokens 723. In various embodiments, reference image tokens 721 and RGB-D tokens 722 are flattened and passed to vision encoder 704. In various embodiments, vision encoder 704 uses a transformer encoder architecture to process reference image tokens 721 and RGB-D tokens 722. Each token is treated as an independent feature vector, enriched with positional embeddings to preserve spatial relationships within the images. In some embodiments, using multi-head self-attention layers, vision encoder 704 learns to capture dependencies between reference image tokens 721 and RGB-D tokens 722, enabling vision encoder 704 to align features from the reference image with features in the current RGB-D view. For example, vision encoder 704 can identify corresponding edges, textures, or regions of interest between reference image tokens 721 and RGB-D tokens 722, ensuring the robot 160 understands how the current scene relates to the goal. Vision encoder 704 then generates vision tokens 723.

In some embodiments, target object mask decoder 706 processes vision tokens 723 and optionally generates target object mask 718 (e.g., one of target object masks 612). Target object mask decoder 706 uses the features embedded in the vision tokens 723 to identify and localize the target object or area of interest within the field of view of robot 160. In various embodiments, target object mask decoder 706 applies a series of upsampling and convolutional layers to reconstruct a semantic or binary mask that highlights the target object in the scene. For example, target object mask decoder 706 can generate a binary target object mask 718 where the pixels corresponding to the target object are marked in white, while the background is marked in black. In a navigation task, target object mask 718 could represent the target region, such as a doorway or docking station. In a manipulation task, target object mask 718 could localize the specific part of an object the robot end effector needs to interact with, such as the handle of a cabinet or the top surface of a table. In various embodiments, target object masks are dynamically updated as robot 160 moves through the environment, ensuring that the robot can maintain accurate localization of the target even when the perspective changes.

Context encoder 705 processes robot size 613, look-at pose 711, LiDAR tokens 720, and vision tokens 723 and generates context tokens 724. In various embodiments, context encoder 705 uses separate neural networks, such as MLPs, to tokenize robot size 613, such as robot footprint, generating robot size tokens, and approach side S, approach distance d, and approach angle θ included in look-at pose 711 generating look-at pose tokens. Context encoder 705 then processes robot size tokens, look-at pose tokens, and vision tokens 723 to generate context tokens 724.

Camera tilt decoder 709 processes context tokens 724 and generates camera tilt 716. In some embodiments, camera tilt decoder 709 is a transformer decoder. In various embodiments, camera tilt decoder 709 uses a regression model to predict camera tilt 716 as a continuous value, ensuring smooth adjustments to the camera orientation at each time step. For example, camera tilt decoder 709 can adjust the camera tilt to center the target object in the image frame or to maintain the object at a specific position, such as ¼ above the bottom of the image, ensuring robot 160 maintains a visual perspective for accurate navigation or manipulation. In various embodiments, camera tilt 716 is updated at a high frequency (e.g., every time step) to adapt to real-time changes in the surroundings of robot 160.

Cross-attention module 707 processes context tokens724 and generates cross-attention features. In various embodiments, context tokens 724 are cross-attended to separate transformer decoders for the base movement (e.g., base trajectory 915) and the camera tilt angle (e.g., camera tilt 716), respectively. For the base movement, cross-attention module 707 identifies features within the context tokens 724 that are useful for base trajectory planning, such as spatial relationships between robot 160 and obstacles, the location of the target object, and the current position of the robot. Similarly, for the camera tilt angle, cross-attention module 707 extracts features that influence the visual perspective of the robot, such as the relative position and orientation of the target object.

Base trajectory decoder 708 processes cross-attention features and generates base trajectory 715. In various embodiments, base trajectory 715 is parameterized as a sequence of waypoints in egocentric polar coordinates, which specify the direction di, distance ry, and heading oi at each point along the trajectory. In some embodiments, to capture the multi-modal nature of robot base trajectories 715, base trajectory decoder 708 uses an autoregressive transformer decoder, which enables base trajectory decoder 708 to predict each waypoint in sequence while accounting for dependencies between waypoints. In such cases, the waypoints can be sampled sequentially conditioned on previous waypoints, so that the waypoints are dependent on previous waypoints rather than being chosen randomly. In various embodiments, to balance precision and computational efficiency, base trajectory decoder 708 uses a multi-token classification strategy with residual predictions. Instead of predicting the entire trajectory as a single entity, base trajectory decoder 708 predicts each waypoint as a sub-action tuple (Ψᵢ, rᵢ, Φᵢ). Each component of the tuple is discretized into bins, for example, Ψ into 30 bins, r into 32 bins, and Φ into 12 bins, which reduces the combinatorial complexity of classification while preserving trajectory accuracy. For each output token z, base trajectory decoder 708 refines the prediction using a residual prediction model, recovering the continuous value

$${z}^{′} = C ( z ) + R ( z , C ( z ) ) , \qquad ( Equation 5 )$$

where C(z) is the output of the classifier and R(z, C(z)) is an MLP that predicts the residual. The combination of classification and residual refinement ensures that the generated base trajectory 715 maintains high precision. The resulting base trajectory 715 specifies a sequence of actions robot 160 has to follow to navigate toward the target object while avoiding obstacles. In some embodiments, base trajectory 715 τ includes T waypoints that are represented by a sequence of subaction-tuples of length T×3, (Ψ₁, r₁, Φ₁), (Ψ₂, r₂, Φ₂),. (Ψ_{T}, r_{T}, Φ_{T}). At inference time, τ is generated by an autoregressive transformer decoder D together with a classifier [symbol] and a residual regressor [symbol] included in base trajectory decoder 708. For example, Ψ₁ can be generated by the following procedure:

$${z}_{{ψ}_{1}} = 𝒟 ( start ) , \qquad ( Equation 6 )$$

$${logits}_{{ψ}_{1}} = 𝒞 ( {z}_{{ψ}_{1}} ) ,$$

$${ψ}_{1}^{onehot} = Sample ( Softmax ( {logits}_{{ψ}_{1}} ) ) ,$$

$${δ}_{{ψ}_{1}} = ℛ ( {ψ}_{1}^{onehot} , {z}_{{ψ}_{1}} ) ,$$

$${ψ}_{1} = {ψ}_{1}^{onehot} + {δ}_{{ψ}_{1}} ,$$

where start is the learned start token. z_{Ψ}_{₁} is the output token from [symbol] [symbol] is the classification MLP that predicts the logits of decretized Ψ₁. The logits are passed into Softmax and then sampled to generate the onehot vector

$${ψ}_{1}^{o n e h o t} .$$

As described in Equation 6, the loss of precision caused by discretization is compensated by predicting the residual

$${δ}_{{ψ}_{1}} = ℛ ( {z}_{{ψ}_{1}} , {ψ}_{1}^{o n e h o t} ) . {z}_{{ψ}_{1}}$$

includes the distribution of Ψ₁ and by conditioning the distribution with the sampled bin

$${ψ}_{1}^{o n e h o t} ,$$

the residual δ_{Ψ1} can be computed. Then, the precise Ψ₁ is computed by adding the residual to the onehot prediction. In some embodiments, after decoding 1, the same procedure as Equation 6 is followed to generate the next subaction r as follows

$${z}_{{r}_{1}} = 𝒟 ( start , ℰ ( {ψ}_{1} ) ) , \qquad ( Equation 7 )$$

$${logits}_{{r}_{1}} = 𝒞 ( {z}_{{r}_{1}} ) ,$$

$${r}_{1}^{onehot} = Sample ( Softmax ( {logits}_{{r}_{1}} ) ) ,$$

$${δ}_{{r}_{1}} = ℛ ( {r}_{1}^{onehot} , {z}_{{r}_{1}} ) ,$$

$${r}_{1} = {r}_{1}^{onehot} + {δ}_{{r}_{1}} ,$$

where the previously predicted full-precision 11 is encoded by an encoder MLP ε and appended into the input sequence to [symbol] .

In various embodiments, base trajectory decoder 708 generates base trajectory 715 in a receding-horizon fashion. Robot 160 follows base trajectory 715 for a fixed number of time steps and then base trajectory decoder 708 generates a new base trajectory 715 given the updated robot observations.

FIG. 8 is a flow diagram of method steps for generating training data 117, according to various embodiments. Although the method steps are described in conjunction with the systems of FIGS. 1-7, persons skilled in the art will understand that any system configured to perform the method steps in any order falls within the scope of the present disclosure.

A method 800 begins at step 801, where simulator 401 is initialized. During step 801, simulator 401 initializes simulation environment 422 to create a virtual space that replicates real-world conditions for robot operation. In some embodiments, initialization includes loading simulation environment 422 with predefined spatial layouts, object configurations, lighting conditions, and dynamic elements. Additionally, simulator 401 initializes the robot model 421, which includes defining the physical and dynamic properties of the robot, such as size, kinematics, footprint, and motion constraints. Parameters such as the collision boundaries, maximum speed, and acceleration limits of the robot are also set at step 401. Simulator 401 also initializes goal specifications generator 423 to ensure that the target objects or regions specified in the task are properly represented and interactable within the simulation. In some embodiments, the total number of training samples included in training data 117 is also initialized.

At step 802, scene sampler 405 generates scene sample 412 based on scene data 153. Scene data 153 includes information about the virtual environment as well as predefined scenarios or parameters for generating diverse environments and environmental variations. In various embodiments, scene sampler 405 processes scene data 153 and generates scene sample 412 tailored to various tasks. For example, scene sampler 405 can position objects in random or structured layouts to simulate pick-and-place tasks, add obstacles in various arrangements to simulate navigation tasks, introduce lighting and texture changes to simulate different operating environments, and/or the like.

At step 803, goal specifications generator 423 generates goal specifications 414 based on scene sample 412. In some embodiments, goal specifications generator 423 generates semantic masks or binary masks that localize the target object in a scene. In various embodiments, simulator 401 generates a reference image I_{R} based on the initial camera view of robot 160 or from a random camera view in the environment, providing a visual context for the task. Goal specifications generator 423 then generates target object mask M randomly from I_{R}, excluding non-objects such as walls and floors. Additionally, goal specifications generator 423 samples a look-at pose C by selecting a side S (e.g., front, back, left, or right), a distance d within a range (e.g., [0.1 m, 0.5 m]), and an angle θ from a set of predefined values (e.g., {0°, +15°, +30°}). Simulator 401 then places robot 160 in simulation environment 422 at the goal position and performs collision checks to ensure a feasible configuration.

At step 804, simulator 401 generates an initial robot state based on goal specifications 414 and robot model 421. In various embodiments, simulator 401 selects a random initial robot state based on goal specifications 414 and robot model 421. In some embodiments, simulator 401 also takes into account the constraints and dynamics of robot model 421, such as kinematic limitations and movement capabilities.

At step 805, trajectory generator 402 generates robot plan 410 based on the initial robot state and goal specifications 414. In various embodiments, trajectory generator 402 interacts with simulator 401 and generates robot plan 410. In various embodiments, trajectory generator 402 uses robot model 421 to compute collision-free base trajectory within simulated environment 422. In some examples, in order to design a base trajectory for robot 160, trajectory generator 402 uses a sampling-based algorithm, such as AIT* in the Reeds-Shepp state space, configured with a fixed turning radius (e.g., 0). In various embodiments, trajectory generator 402 is adaptable and can design base trajectory for other robot kinematics by altering the state space and related constraints. In various embodiments, trajectory generator 402 uses a cost function during the design of the base trajectory that encourages robot 160 to maintain forward motion and minimize excessive backward movement. In some examples, trajectory generator 402 allows base trajectory with small backward motions whenever the base trajectory result in a faster route to the goal. In various embodiments, for each feasible base trajectory, trajectory generator 402 also renders camera observations along the path, maintaining a fixed distance gap (e.g., 0.2 meters) or an angular gap (e.g., 5 degrees) between successive observations. Trajectory generator 402 adjusts camera tilt such that the lowest vertex of the target object's mesh appears at a fixed position (e.g., ¼) above the bottom of the image. Trajectory generator 410 then generates robot plan 410, which includes collision-free base trajectory and camera tilt.

At step 806, simulator 401 generates multi-modal inputs413 based on robot plan 410. In various embodiments, simulator 401 simulates RGB-D inputs and LiDAR inputs along the base trajectory included in robot plan 410, as well as robot state data. In some embodiments, to generate RGB-D inputs, simulator 401 uses simulation tools, such as Nvidia Isaac Sim, which provides photorealistic rendering and accurate depth estimation. The RGB component is rendered using virtual cameras placed at the viewpoint of robot 160, capturing high-resolution images of the scene. The depth component is calculated based on the simulated distances from the camera to objects in the simulation environment 422, creating a depth map that corresponds to the perspective of robot 160. LiDAR inputs are simulated by emitting virtual laser beams from the LiDAR sensor model and measuring the simulated distances to objects and surfaces within simulation environment 422. The LiDAR scans are processed to generate point clouds that provide precise spatial data, including the shapes, positions, and distances of obstacles and objects in the surroundings of robot 160. In various embodiments, simulator 401 accounts for environmental factors, such as lighting, occlusions, and reflective surfaces, to ensure the LiDAR inputs are realistic and representative of real-world conditions. Robot state data is computed based on a kinematic model included in robot model 421 and the base trajectory included in robot plan 410. Simulator 401 updates the state of robot 160 dynamically as the robot moves along the base trajectory.

At step 807, data augmentation module 403 generates training data 117 based on multi-modal inputs 413, goal specifications 414, and robot plan 410. In various embodiments, data augmentation module 403 applies various transformations to enhance the diversity and robustness of training data 117, such as introducing variations in lighting, object textures, and environmental noise to simulate different operating conditions. Data augmentation module 403 can also adjust the RGB-D inputs by altering camera angles, cropping, or resizing images to account for different robot configurations and viewpoints. Additionally, data augmentation module 403 can modify LiDAR inputs by adding noise or simulating sensor occlusions to mimic challenging conditions, such as cluttered environments, poor visibility, and/or the like. In some embodiments, data augmentation module 403 augments the robot state data by slightly perturbing positions or velocities to provide a broader distribution of possible base trajectories. In various embodiments, data augmentation module 403 augments the target object mask data and goal specifications 414 by varying target object placements, approach angles, and distances.

At step 808, data generator 115 checks whether to generate more training data 817. In various embodiments, data generator 115 checks whether the total number of training samples has reached a predefined number. If the total number of training samples has reached a predefined number, method 800 terminates and data generator 115 stores training data 117 in memory 114 or any other suitable storage device, such as datastore 120. If the total number of training samples has not reached a predefined number, method 800 returns to step 802.

FIG. 9 is a flow diagram of method steps for training vision-based robot control model 154, according to various embodiments. Although the method steps are described in conjunction with the systems of FIGS. 1-7, persons skilled in the art will understand that any system configured to perform the method steps in any order falls within the scope of the present disclosure.

A method 900 begins with step 901, wherein model trainer 116 is initialized. In various embodiments, model trainer 116 initializes one or more parameters of vision-based robot control model 154 randomly or using techniques, such as Xavier or He initialization, depending on the activation functions and architecture of vision-based robot control model 154. In some embodiments, during initialization, model trainer 116 assigns weights to each layer of vision-based robot control model 154, drawing from a normal or uniform distribution scaled based on the number of input and output neurons for each layer. Additionally, model trainer 116 can initialize other hyperparameters, such as learning rate, batch size, and the number of training epochs, as part of the initialization process to optimize the training workflow.

At step 902, model trainer 116 performs behavior cloning training based on training data 117. Vision-based robot control model 154 generates robot plans 511 based on training data 117. In various embodiments, at every training epoch, vision-based robot control model 154 processes training data 117 and generates robot plan 511. In various embodiments, loss calculation module 501 processes ground truth data 510, which includes ground truth robot plans, and robot plans 511, generated by vision-based robot control model 154, and computes a loss. In various embodiments, loss calculation module 401 computes the loss L, which includes three components: Lₘₐₛₖ, L_{base}, and Lₜᵢₗₜ. The term Lₘₐₛₖ is a pixel-wise L2 loss that regresses the target object masks in all history frames, which can be computed as described in Equation 1. The term L_{base} includes both classification loss and regression loss for each waypoint of the base trajectory, where the classification loss handles discrete waypoint categories or classes along the base trajectory. The regression loss refines continuous base trajectory parameters, such as the exact direction, distance, and heading angle robot 160 at each step along the base trajectory. In some examples, L_{base} can be computed as described in Equation 2. Lastly, Lₜᵢₗₜ is an L2 loss that regresses the camera tilt angle, ensuring proper alignment of the camera's field of view with the target object. In some examples, Lₜᵢₗₜ can be computed as described in Equation 3. In some embodiments, model trainer 116 updates vision-based robot control model 154 based on the computed loss. In various embodiments, model trainer 116 updates the one or more parameters of vision-based robot control model 154 based on the loss. The update process is performed using an optimization algorithm, such as SGD, Adam, or RMSprop. In some embodiments, model trainer 116 begins training vision-based robot control model 154 with a behavior cloning phase, where model trainer 116 trains vision-based robot control model 154 to imitate expert demonstrations from training data 117. After the behavior cloning phase, model trainer 116 tests vision-based robot control model 154 in simulation to identify potential failures, such as collisions, tracking losses, or deviations from the desired base trajectory included in ground truth data 510.

In various embodiments, vision-based robot control model 154 includes various encoders, such as a look-at-pose encoder, robot size encoder, a LiDAR encoder 701, a reference image encoder 702, an RGB-D encoder 703, a vision encoder 704, and/or the like, which may be fixed during training or pre-trained on relevant datasets. In various embodiments, during training, model trainer 116 randomly selects a base trajectory included in training data 117 and an observation index to generate one training sample. In some examples, the ground truth waypoints included in base trajectory and camera tilt are computed at the observation index, where the number of waypoints and the discretization of the waypoints can be adjusted.

At step 903, model trainer 116 performs DAgger training based on failure evaluations. In some embodiments, the failures can be addressed by augmenting training data 117 using the DAgger technique. In some embodiments, model trainer 116 uses the DAgger technique to generate more training data that includes the failure cases. In some embodiments, model trainer 116 trains vision-based robot control model 154 as described in Algorithm 1.

At step 904, model trainer 116 checks whether to continue training. In various embodiments, model trainer 116 decides to stop training based on one or more convergence criteria to ensure vision-based robot control model 154 has learned the task without overfitting to training data 117. The criteria include monitoring the loss during training and stopping when the total loss L stabilizes or falls below a predefined threshold. Additionally, model trainer 116 evaluates the performance of vision-based robot control model 154 on a validation dataset that is separate from training data 117. If the validation loss stops decreasing or begins to increase, model trainer 116 infers overfitting and model trainer 116 stop training. In some embodiments, early stopping techniques are used, where training halts if no improvement in validation performance is observed for a specified number of epochs. Model trainer 116 can use other methods to stop training. For example, model trainer 116 can monitor specific metrics, such as trajectory accuracy, collision rate, or task completion success rate. If model trainer 116 decides to stop training, the method 900 terminates and model trainer 116 stores vision-based robot control model 154 in datastore 120 or any suitable storage device. If model trainer 116 decides to continue training, the method 900 returns to step 902.

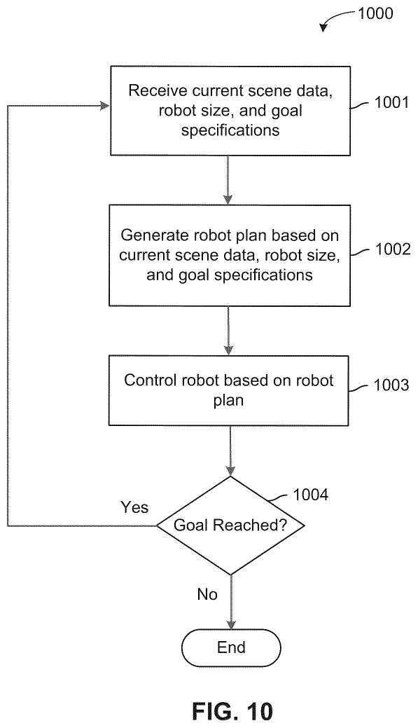

FIG. 10 is a flow diagram of method steps for controlling a robot 160, according to various embodiments. Although the method steps are described in conjunction with the systems of FIGS. 1-7, persons skilled in the art will understand that any system configured to perform the method steps in any order falls within the scope of the present disclosure.

A method 1000 begins with step 1001, wherein robot control application 116 receives current scene data 610, goal specifications 614, and robot size 613. In some embodiments, goal specifications 614 can be given via I/O devices 150 in terms of natural language or text prompts that describe the task or desired robot behavior. Robot control application 116 interprets the prompts using various natural language processing (NLP) techniques and translates the prompts into structured goal specifications 614, such as the approach side(S), approach distance (d), and approach angle (θ), as well as generating target object masks M.

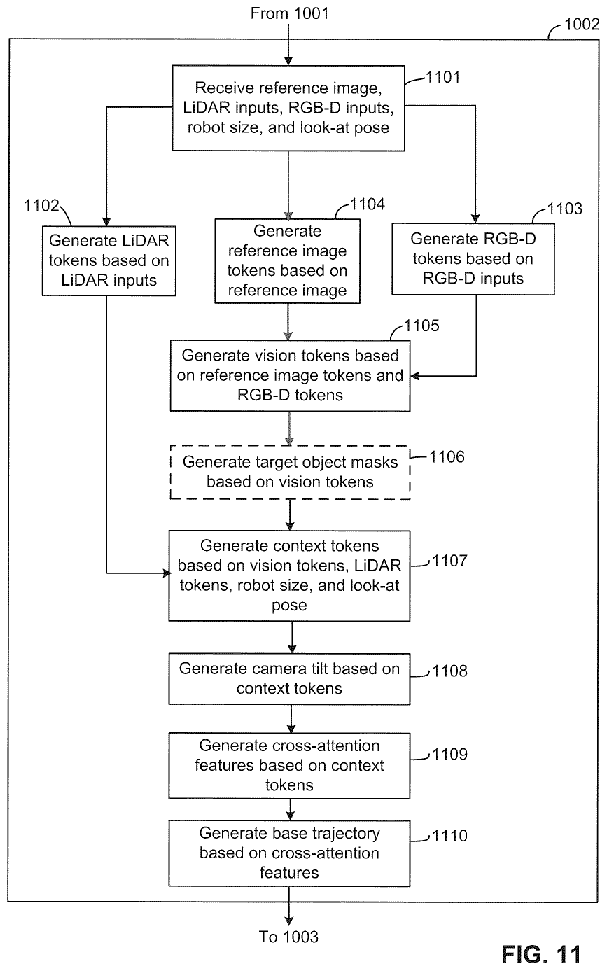

At step 1002, the trained vision-based robot control model 154 generates robot plan 611 based on current scene data 610, robot size 613, and goal specifications 614. In various embodiments, vision-based robot control model 154 uses various transformer-based architectures, where components such as encoders, decoders, and cross-attention modules process robot size 613, multi-modal inputs included in current scene data 610, and goal specifications 614 and generates base trajectory 715 and camera tilt 716 included in robot plan 611. In various embodiments, the trained vision-based robot control model 154 also optionally generates target object masks 612. Step 1002 is described in more detail in conjunction with FIG. 11.

At step 1003, robot control application 116 controls robot160 based on robot plan 611. In various embodiments, the trained vision-based robot control model 154 generates base trajectory and camera tilt at different frequencies to optimize robot control. For the base trajectory, the trained vision-based robot control model 154 can operate in a receding-horizon fashion: the model generates a base trajectory for up a fixed T number of steps, which robot 160 follows. After executing T steps, vision-based robot control model 154 generates a new base trajectory based on updated observations included in current scene data 610. For camera tilt, vision-based robot control model 154 can generate a new value at every time step, ensuring the camera remains aligned with the target object or area of interest throughout the operation of robot 160.

At step 1004, robot control application 116 checks whether the goal has been reached. In various embodiments, robot control application 116 continuously monitors whether robot 160 has reached the goal specified in goal specifications 614. In some embodiments, the criterion for determining goal completion is based on evaluating the cumulative change in position and heading between sequential waypoints in the generated trajectory included in robot plan 611. In some examples, robot control application 116 determines that robot 160 has reached the goal when the total Euclidean distance between all sequential waypoints in the trajectory is less than a threshold (e.g., 0.05 m), and the total absolute change in heading between sequential waypoints is less than a threshold (e.g., 2.5 degrees). If the goal has been reached, the method 1000 terminates. If the goal has not been reached, the method 1000 returns to step 1001.

FIG. 11 is a flow diagram of method steps for generating a robot plan 611 using a trained vision-based robot control model 154, according to various embodiments. Although the method steps are described in conjunction with the systems of FIGS. 1-7, persons skilled in the art will understand that any system configured to perform the method steps in any order falls within the scope of the present disclosure.

As shown, step 1002 of method 1000 begins with step 1101, wherein the trained vision-based robot control model 154 receives reference image 614, LiDAR inputs 712, RGB-D inputs 714, robot size 613, and look-at pose 711. In various embodiments, vision-based robot control model 154 receives look-at pose 711 and reference image 614 included in goal specifications 614, robot size 613, LiDAR inputs 712, and RGB-D inputs 714 included in current scene data 610.

At step 1102, LiDAR encoder 701 generates LiDAR tokens 720 based on LiDAR inputs 712. In various embodiments, LiDAR encoder 701 resamples the LiDAR points included in LiDAR inputs 712 to a fixed number, such as 256 points, to ensure uniformity in the input data. The points are then grouped into a fixed number of directional bins (e.g., 32) based on the spatial distribution, with each bin containing a subset of points (e.g., 8 points) represented by the corresponding (x, y) coordinates. Within each bin, LiDAR encoder 701 processes the grouped points using a neural network, such as an MLP, which extracts high-level features and compresses the data into a single LiDAR token 720 per bin. As a result, LiDAR encoder 701 generates a total fixed number of LiDAR tokens 720 (e.g., 32), each representing the spatial features of a specific directional segment of the environment.

At step 1103, RGB-D encoder 703 generates RGB-D tokens 722 based on RGB-D inputs 714. In various embodiments, the RGB component of RGB-D inputs 714 It (e.g., a 224×224×3 image) is passed through a frozen MAE-Base to extract a fixed size feature map (e.g., a 14×14×512 feature map), reducing the image size while preserving key features. The depth component of RGB-D inputs 714 is resized to match the resolution of the RGB feature map (e.g., 14×14) and is used to compute the spatial location of each depth pixel in the egocentric coordinate frame of robot 160. In various embodiments, RGB-D encoder 703 uses the transformation described in Equation 1. Sinusoidal position embeddings are then computed for the coordinates and concatenated with the corresponding RGB feature patches, incorporating depth information into the visual tokens. In various embodiments, RGB-D encoder 703 also uses camera extrinsics derived from the odometry of robot 160, to account for the position and orientation of robot 160 over time.

At step 1104, reference image encoder 702 generates reference image tokens 721 based on reference image 614. In various embodiments, reference image encoder 702 tokenizes reference image 614 using the same frozen MAE used for RGB inputs 714 at step 1103. Specifically, reference image 614, which represents a visual snapshot of the target object or area in the environment, is resized (e.g., to 224×224 pixels) and passed through the MAE to extract a fixed size feature map (e.g., a 14×14×512 feature map) included in reference image tokens 721. In some embodiments, a target object mask M is also encoded by a shallow convolutional network. In various embodiments, steps 1102-1104 can be performed sequentially or concurrently.

At step 1105, vision encoder 704 generates vision tokens723 based on reference image tokens 721 and RGB-D tokens 722. In some embodiments, reference image tokens 721 and RGB-D tokens 722 are flattened and passed to vision encoder 704. In some embodiments, vision encoder 704 uses a transformer encoder architecture to process reference image tokens 721 and RGB-D tokens 722. Each token is treated as an independent feature vector, enriched with positional embeddings to preserve spatial relationships within the images. In some embodiments, using multi-head self-attention layers, vision encoder 704 learns to capture dependencies between reference image tokens 721 and RGB-D tokens 722, enabling vision encoder 704 to align features from the reference image with features in the current RGB-D view. For example, vision encoder 704 can identify corresponding edges, textures, or regions of interest between reference image tokens 721 and RGB-D tokens 722. Vision encoder 704 then generates vision tokens 723.

At optional step 1106, target object mask decoder 706 generates target object masks 612 based on vision tokens 723. In various embodiments, target object mask decoder 706 uses the features embedded in the vision tokens 723 to identify and localize the target object or area of interest within the field of view of robot 160. In various embodiments, target object mask decoder 706 applies a series of upsampling and convolutional layers to reconstruct a semantic or binary mask that highlights the target object in the scene. In various embodiments, target object masks 612 are dynamically updated as robot 160 moves through the environment.

At step 1107, context encoder 705 generates context tokens 724 based on vision tokens 723, LiDAR tokens 720, robot size 613, and look-at pose 711. In various embodiments, context encoder 705 uses separate neural networks, such as MLPs, to tokenize robot size 613, such as a robot footprint, generating robot size tokens, approach side, approach distance, and approach angle included in look-at pose 711, generating look-at pose tokens. Context encoder 705 then processes robot size tokens, look-at pose tokens, and vision tokens 723 to generate context tokens 724.

At step 1108, camera tilt decoder 709 generates camera tilt 716 based on context tokens 724. In some embodiments, camera tilt decoder 709 is a transformer decoder. In various embodiments, camera tilt decoder 709 uses a regression model to predict camera tilt 716 as a continuous value, ensuring smooth adjustments to the camera orientation at each time step. For example, camera tilt decoder 709 can adjust the camera tilt to center the target object in the image frame or to maintain the object at a specific position, such as ¼ above the bottom of the image. In various embodiments, camera tilt 716 is updated at a high frequency (e.g., every time step) to adapt to real-time changes in the surroundings of robot 160.

At step 1109, cross-attention module 707 generates cross-attention features based on context tokens 724. In various embodiments, cross-attention module 707 cross-attends context tokens 724 to separate transformer decoders for the base movement (e.g., base trajectory 915) and the camera tilt angle (e.g., camera tilt 716), respectively. For the base movement, cross-attention module 707 identifies features within the context tokens 724 that are useful for base trajectory planning, the location of the target object, and the current position of robot 160. Similarly, for the camera tilt angle, cross-attention module 707 extracts features that influence the visual perspective of robot 160.

At step 1110, base trajectory decoder 708 generates base trajectory 715 based on cross-attention features. In various embodiments, base trajectory 715 is parameterized as a sequence of waypoints in egocentric polar coordinates. In some embodiments, to capture the multi-modal nature of robot base trajectories 715, base trajectory decoder 708 uses an autoregressive transformer decoder, which enables base trajectory decoder 708 to predict each waypoint in the sequence while accounting for dependencies between other waypoints. In such cases, the waypoints can be sampled sequentially conditioned on previous waypoints. In various embodiments, base trajectory decoder 708 uses a multi-token classification strategy with residual predictions. Instead of predicting the entire trajectory as a single entity, base trajectory decoder 708 predicts each waypoint as a sub-action tuple. Each component of the tuple is discretized into bins. For each output token, base trajectory decoder 708 refines the prediction using a residual prediction model, recovering the continuous value as described by Equation 5. In some embodiments, base trajectory 715 includes T waypoints that are represented by a sequence of subaction-tuples of length T×3, (Ψ₁, r₁, Φ₁), (Ψ₂, r₂, Φ₂),, (Ψ_{T}, r_{T}, Φ_{T}). At inference time, base trajectory 715 can be generated by an autoregressive transformer decoder D together with a classifier [symbol] and a residual regressor [symbol] included in base trajectory decoder 708. In some examples, the subaction-tuples can be generated as described by Equations 6 and 7.

In various embodiments, base trajectory decoder 708 generates base trajectory 715 in a receding-horizon fashion. Robot 160 follows base trajectory 715 for a fixed number of time steps and then base trajectory decoder 708 generates a new base trajectory 715 given the updated robot observations.

In sum, techniques are disclosed for training a vision-based robot control model. In various embodiments, a scene sampler generates a set of scene samples that includes a plurality of scenes by sampling different objects, layouts for the objects, and lighting from scene data to include in the plurality of scenes. Using a robot model and the scene sample, a simulator generates an initial robot state and a goal robot state, which define the starting position of the robot and the target goal for a given task in a simulation environment. The simulator also generates goal specifications, which include a reference image, look-at pose, and a target object mask. The reference image is generated based on the initial and goal robot states, which visually represents the environment as seen from the robot's perspective, including the target object or area the robot needs to interact with and the relative robot position in the scene. In some embodiments, the target object mask is also generated to highlight the target object or region of interest included in the reference image. A trajectory generator then computes a robot plan, which includes a collision-free base trajectory and camera tilts, using the robot model, the initial state, and the goal state in the simulation environment. Based on the robot plan, the simulator generates multi-modal inputs for training the vision-based robot control model. The multi-modal inputs can include RGB-D inputs, LiDAR inputs, and the robot state data along the base trajectory that is collected from the simulator. In some embodiments, the multi-modal inputs, goal specifications, and robot plan are passed to a data augmentation module to enhance diversity and robustness, resulting in training data. In various embodiments, a model trainer uses the training data to train a vision-based robot control model over a plurality of training epochs. During training, the vision-based robot control model processes the training data and generates robot plans. A loss calculation module processes ground truth data included in the training data and the robot plans to compute a loss. The model trainer uses the loss to update one or more parameters of the vision-based control model.

In some embodiments, the vision-based robot control model is configured to process a robot size, a look-at-pose, LiDAR inputs, a reference image, and RGB-D inputs and generate a base trajectory, a camera tilt, and, optionally, one or more target object masks. In some embodiments, the vision-based robot control model includes a LiDAR encoder, a reference image encoder, an RGB-D encoder, a vision encoder, a context encoder, a target object mask decoder, a camera tilt decoder, a cross-attention module, and a base trajectory decoder. The LiDAR encoder processes LiDAR inputs to generate LiDAR tokens. The reference image encoder processes the reference image and generates reference image tokens. The RGB-D encoder processes RGB-D inputs and generates RGB-D tokens. The vision encoder processes reference image tokens and RGB-D tokens and generates vision tokens. Optionally, the target object mask decoder processes vision tokens and generates target object masks. The context encoder processes robot size, look-at pose, LiDAR tokens, and vision tokens and generates context tokens. The camera tilt decoder processes context tokens and generates a camera tilt. The cross-attention module processes context tokens and generates cross-attention features. The base trajectory decoder processes cross-attention features and generates a base trajectory. A robot control application can use the base trajectory and camera tilt to control a robot.

At least one technical advantage of the disclosed techniques relative to the prior art is that the disclosed techniques use a vision-based robot control model to achieve high precision and adaptability in dynamic or unstructured environments. Unlike prior approaches that rely on fixed success criteria, the disclosed techniques enable high precision in robot positioning, including centimeter-level accuracy positioning. The disclosed techniques are also adaptable in that predefined object models or CAD files are not required for object localization and manipulation. A further advantage of the disclosed techniques is the use of continuous action spaces, which enables fluid and precise movements rather than limiting robots to a discrete set of predefined actions. Additionally, the disclosed techniques address the drawbacks of imprecise datasets used in prior art approaches by generating training data based on scene data, which can include predefined object libraries and virtual environments. These technical advantages provide one or more technological improvements over prior art approaches.

1. In some embodiments, a computer-implemented method for training a vision-based robot control model comprises generating, based on scene data, a plurality of scenes, generating, based on the plurality of scenes, one or more goal specifications, determining, based on the one or more goal specifications and a robot model, one or more robot plans, generating, based on the one or more robot plans and the plurality of scenes, simulated sensor data, and performing one or more training operations to generate a trained vision-based robot control model based on the one or more goal specifications, the one or more robot plans, and the simulated sensor data.

2. The method of clause 1, wherein determining each robot plan included in the one or more robot plans comprises generating, based on the one or more goal specifications and the robot model, an initial robot state, and generating, based on the one or more goal specifications and the initial robot state, the robot plan.

3. The method of clauses 1 or 2, wherein the simulated sensor data comprises at least one of a plurality of red-green-blue images with depth (RGB-D) inputs, a plurality of light detection and ranging (LiDAR) inputs, or robot state data generated along the one or more robot plans.

4. The method of any of clauses 1-3, wherein each robot plan included in the one or more robot plans includes at least one of a trajectory of a base of a robot or a tilt of a camera mounted on the robot.

5. The method of any of clauses 1-4, wherein the one or more goal specifications include a reference image, a look-at pose, and a target object mask.

6. The method of any of clauses 1-5, wherein the look-at pose includes at least one of an approach angle, an approach distance, or an approach direction.

7. The method of any of clauses 1-6, further comprising simulating, based on the plurality of scenes, a plurality of scenarios with at least one of one or more object configurations, one or more environmental layouts, or one or more lighting conditions.

8. The method of any of clauses 1-7, wherein performing one or more training operations to generate the trained vision-based robot control model comprises generating, based on the one or more goal specifications and the simulated sensor data, one or more predicted robot plans using the vision-based robot control model, computing, based on the one or more predicted robot plans and the one or more robot plans, one or more loss values, and updating, based on the one or more loss values, one or more parameters of the vision-based robot control model.

9. The method of any of clauses 1-8, wherein the one or more loss values are computed based on at least one of a target object mask loss, a base trajectory loss, or a camera tilt loss.

10. The method of any of clauses 1-9, further comprising receiving sensor data and one or more additional goal specifications, processing the sensor data, a robot size, and the one or more additional goal specifications to generate a robot plan using the trained vision-based robot control model, and controlling a robot based on the robot plan.

11. In some embodiments, one or more non-transitory computer readable media store instructions that, when executed by one or more processors, cause the one or more processors to perform the steps of generating, based on scene data, a plurality of scenes, generating, based on the plurality of scenes, one or more goal specifications, determining, based on the one or more goal specifications and a robot model, one or more robot plans, generating, based on the one or more robot plans and the plurality of scenes, simulated sensor data, and performing one or more training operations to generate a trained vision-based robot control model based on the one or more goal specifications, the one or more robot plans, and the simulated sensor data.

12. The one or more non-transitory computer-readable media of clause 11, wherein determining each robot plan included in the one or more robot plans comprises generating, based on the one or more goal specifications and the robot model, an initial robot state, and generating, based on the one or more goal specifications and the initial robot state, the robot plan.

13. The one or more non-transitory computer-readable media of clauses 11 or 12, wherein the instructions, when executed by the one or more processors, further cause the one or more processors to perform the step of simulating, based on the plurality of scenes, a plurality of scenarios with at least one of one or more object configurations, one or more environmental layouts, or one or more lighting conditions.

14. The one or more non-transitory computer-readable media of any of clauses 11-13, wherein the robot model comprises a differential-drive model.

15. The one or more non-transitory computer-readable media of any of clauses 11-14, wherein determining the one or more robot plans comprises performing one or more sampling-based operations.

16. The one or more non-transitory computer-readable media of any of clauses 11-15, wherein performing one or more training operations to generate the trained vision-based robot control model comprises generating, based on the one or more goal specifications and the simulated sensor data, one or more predicted robot plans using the vision-based robot control model, computing, based on the one or more predicted robot plans and the one or more robot plans, one or more loss values, and updating, based on the one or more loss values, one or more parameters of the vision-based robot control model.

17. The one or more non-transitory computer-readable media of any of clauses 11-16, wherein the one or more loss values are computed based on at least one of a target object mask loss, a base trajectory loss, or a camera tilt loss.

18. The one or more non-transitory computer-readable media of any of clauses 11-17, wherein performing one or more training operations comprises performing one or more behavior cloning operations in which the trained vision-based robot control model is trained to imitate the one or more robot plans.

19. The one or more non-transitory computer-readable media of any of clauses 11-18, wherein the instructions, when executed by the one or more processors, further cause the one or more processors to perform the steps of receiving sensor data and one or more additional goal specifications, processing the sensor data, a robot size, and the one or more additional goal specifications to generate a robot plan using the trained vision-based robot control model, and controlling a robot based on the robot plan.

20. In some embodiments, a system comprises one or more memories storing instructions, and one or more processors that are coupled to the one or more memories and, when executing the instructions, are configured to generate, based on scene data, a plurality of scenes, generate, based on the plurality of scenes, one or more goal specifications, determine, based on the one or more goal specifications and a robot model, one or more robot plans, generate, based on the one or more robot plans and the plurality of scenes, simulated sensor data, and perform one or more training operations to generate a trained vision-based robot control model based on the one or more goal specifications, the one or more robot plans, and the simulated sensor data.

1. In some embodiments, a computer-implemented method for controlling a robot comprises receiving sensor data and one or more goal specifications, processing the sensor data, a robot size, and the one or more goal specifications using one or more trained encoders to generate a plurality context tokens, processing the plurality of context tokens using one or more trained decoders to generate a robot plan, and controlling a robot based on the robot plan.

2. The method of clause 1, wherein the sensor data includes at least one of a plurality of red-green-blue images with depth (RGB-D) inputs, a plurality of light detection and ranging (LiDAR) inputs, or robot state data.

3. The method of clauses 1 or 2, wherein the one or more goal specifications include at least one of a reference image, a look-at pose, and a target object mask.

4. The method of any of clauses 1-3, wherein processing the sensor data, the robot size, and the one or more goal specifications using the one or more trained encoders comprises processing a plurality of LiDAR inputs using a first trained encoder included in the one or more trained encoders to generate a plurality of LiDAR tokens, processing a plurality of RGB-D inputs using a second trained encoder included in the one or more trained encoders to generate a plurality of RGB-D tokens, processing a reference image using a third trained encoder included in the one or more trained encoders to generate a plurality of reference image tokens, processing the plurality of reference image tokens and the plurality of RGB-D tokens using a fourth trained encoder included in the one or more trained encoders to generate a plurality of vision tokens, and processing the plurality of vision tokens, the plurality of LiDAR tokens, the robot size, and a look-at pose using a fifth trained encoder included in the one or more trained encoders to generate the plurality of context tokens.

5. The method of any of clauses 1-4, wherein processing the plurality of LiDAR inputs comprises generating, based on the plurality of LiDAR inputs, one or more directional bins, and generating, based on the one or more directional bins and using the first trained encoder, the plurality of LiDAR tokens.

6. The method of any of clauses 1-5, wherein processing the plurality of RGB-D inputs comprises generating, based on the plurality of RGB-inputs, a fixed size feature map using a frozen Masked Autoencoder.

7. The method of any of clauses 1-6, wherein processing the reference image comprises generating, based on the reference image and using a frozen Masked Autoencoder, a fixed size feature map.

8. The method of any of clauses 1-7, wherein processing the plurality of vision tokens, the plurality of LiDAR tokens, the robot size, and the look-at pose comprises generating, based on the robot size and using a first neural network, a plurality of robot size tokens, generating, based on the look-at pose and using a second neural network, a plurality of look-at pose tokens, and generating, based on the plurality of robot size tokens and the plurality of look-at pose tokens, the plurality of context tokens.

9. The method of any of clauses 1-8, wherein processing the plurality of context tokens comprises determining, based on the plurality of context tokens and using a first trained decoder included in the one or more trained decoders, a camera tilt.

10. The method of any of clauses 1-9, wherein processing the plurality of context tokens comprises generating, based on the plurality of context tokens, a plurality of cross-attention features, and generating, based on the plurality of cross-attention features and using a first trained decoder included in the one or more trained decoders, a trajectory for the robot.

11. In some embodiments, one or more non-transitory computer readable media store instructions that, when executed by one or more processors, cause the one or more processors to perform the steps of receiving sensor data and one or more goal specifications, processing the sensor data, a robot size, and the one or more goal specifications using one or more trained encoders to generate a plurality context tokens, processing the plurality of context tokens using one or more trained decoders to generate a robot plan, and controlling a robot based on the robot plan.

12. The one or more non-transitory computer-readable media of clause 11, wherein processing the sensor data, the robot size, and the one or more goal specifications using the one or more trained encoders comprises generating, based on a plurality of LiDAR inputs, one or more directional bins, generating, based on the one or more directional bins and using a first trained encoder included in the one or more trained encoders, a plurality of LiDAR tokens, processing a plurality of RGB-D inputs using a second trained encoder included in the one or more trained encoders to generate a plurality of RGB-D tokens, processing a reference image using a third trained encoder included in the one or more trained encoders to generate a plurality of reference image tokens, processing the plurality of reference image tokens and the plurality of RGB-D tokens using a fourth trained encoder included in the one or more trained encoders to generate a plurality of vision tokens, and processing the plurality of vision tokens, the plurality of LiDAR tokens, the robot size, and a look-at pose using a fifth trained encoder included in the one or more trained encoders to generate the plurality of context tokens.

13. The one or more non-transitory computer-readable media of clauses 11 or 12, wherein processing the plurality of vision tokens, the plurality of LiDAR tokens, the robot size, and the look-at pose comprises generating, based on the robot size and using a first neural network, a plurality of robot size tokens, generating, based on the look-at pose and using a second neural network, a plurality of look-at pose tokens, and generating, based on the plurality of robot size tokens and the plurality of look-at pose tokens, the plurality of context tokens.

14. The one or more non-transitory computer-readable media of any of clauses 11-13, wherein a first trained decoder included in the one or more trained decoders comprises at least one of a transformer decoder or a regression model.

15. The one or more non-transitory computer-readable media of any of clauses 11-14, wherein processing the plurality of context tokens comprises determining, based on the plurality of context tokens and using a first trained decoder included in the one or more trained decoders, a camera tilt.

16. The one or more non-transitory computer-readable media of any of clauses 11-15, wherein the first trained decoder comprises a multi-token classification technique with a residual model.

17. The one or more non-transitory computer-readable media of any of clauses 11-16, wherein processing the plurality of context tokens comprises generating, based on the plurality of context tokens, a plurality of cross-attention features, and generating, based on the plurality of cross-attention features and using a first trained decoder included in the one or more trained decoders, a trajectory for the robot.

18. The one or more non-transitory computer-readable media of any of clauses 11-17, wherein the trajectory includes one or more waypoints in egocentric polar coordinates.

19. The one or more non-transitory computer-readable media of any of clauses 11-18, wherein a first trained encoder included in the one or more trained encoder receives as input camera extrinsics derived from odometry of the robot.

20. In some embodiments, a system comprises one or more memories storing instructions, and one or more processors that are coupled to the one or more memories and, when executing the instructions, are configured to receive sensor data and one or more goal specifications, process the sensor data, a robot size, and the one or more goal specifications using one or more trained encoders to generate a plurality context tokens, process the plurality of context tokens using one or more trained decoders to generate a robot plan, and control a robot based on the robot plan.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling a robot, the method comprising:
receiving sensor data and one or more goal specifications;
processing the sensor data, a robot size, and the one or more goal specifications using one or more trained encoders to generate a plurality context tokens;
processing the plurality of context tokens using one or more trained decoders to generate a robot plan; and
controlling a robot based on the robot plan.

2. The method of claim 1, wherein the sensor data includes at least one of a plurality of red-green-blue images with depth (RGB-D) inputs, a plurality of light detection and ranging (LiDAR) inputs, or robot state data.

3. The method of claim 1, wherein the one or more goal specifications include at least one of a reference image, a look-at pose, and a target object mask.

4. The method of claim 1, wherein processing the sensor data, the robot size, and the one or more goal specifications using the one or more trained encoders comprises:
processing a plurality of LiDAR inputs using a first trained encoder included in the one or more trained encoders to generate a plurality of LiDAR tokens;
processing a plurality of RGB-D inputs using a second trained encoder included in the one or more trained encoders to generate a plurality of RGB-D tokens;
processing a reference image using a third trained encoder included in the one or more trained encoders to generate a plurality of reference image tokens;
processing the plurality of reference image tokens and the plurality of RGB-D tokens using a fourth trained encoder included in the one or more trained encoders to generate a plurality of vision tokens; and
processing the plurality of vision tokens, the plurality of LiDAR tokens, the robot size, and a look-at pose using a fifth trained encoder included in the one or more trained encoders to generate the plurality of context tokens.

5. The method of claim 4, wherein processing the plurality of LiDAR inputs comprises:
generating, based on the plurality of LiDAR inputs, one or more directional bins; and
generating, based on the one or more directional bins and using the first trained encoder, the plurality of LiDAR tokens.

6. The method of claim 4, wherein processing the plurality of RGB-D inputs comprises generating, based on the plurality of RGB-inputs, a fixed size feature map using a frozen Masked Autoencoder.

7. The method of claim 4, wherein processing the reference image comprises generating, based on the reference image and using a frozen Masked Autoencoder, a fixed size feature map.

8. The method of claim 4, wherein processing the plurality of vision tokens, the plurality of LiDAR tokens, the robot size, and the look-at pose comprises:
generating, based on the robot size and using a first neural network, a plurality of robot size tokens;
generating, based on the look-at pose and using a second neural network, a plurality of look-at pose tokens; and
generating, based on the plurality of robot size tokens and the plurality of look-at pose tokens, the plurality of context tokens.

9. The method of claim 1, wherein processing the plurality of context tokens comprises determining, based on the plurality of context tokens and using a first trained decoder included in the one or more trained decoders, a camera tilt.

10. The method of claim 1, wherein processing the plurality of context tokens comprises:
generating, based on the plurality of context tokens, a plurality of cross-attention features; and
generating, based on the plurality of cross-attention features and using a first trained decoder included in the one or more trained decoders, a trajectory for the robot.

11. One or more non-transitory computer readable media storing instructions that, when executed by one or more processors, cause the one or more processors to perform the steps of:
receiving sensor data and one or more goal specifications;
processing the sensor data, a robot size, and the one or more goal specifications using one or more trained encoders to generate a plurality context tokens;
processing the plurality of context tokens using one or more trained decoders to generate a robot plan; and
controlling a robot based on the robot plan.

12. The one or more non-transitory computer-readable media of claim 11, wherein processing the sensor data, the robot size, and the one or more goal specifications using the one or more trained encoders comprises:
generating, based on a plurality of LiDAR inputs, one or more directional bins;
generating, based on the one or more directional bins and using a first trained encoder included in the one or more trained encoders, a plurality of LiDAR tokens;
processing a plurality of RGB-D inputs using a second trained encoder included in the one or more trained encoders to generate a plurality of RGB-D tokens;
processing a reference image using a third trained encoder included in the one or more trained encoders to generate a plurality of reference image tokens;
processing the plurality of reference image tokens and the plurality of RGB-D tokens using a fourth trained encoder included in the one or more trained encoders to generate a plurality of vision tokens; and
processing the plurality of vision tokens, the plurality of LiDAR tokens, the robot size, and a look-at pose using a fifth trained encoder included in the one or more trained encoders to generate the plurality of context tokens.

13. The one or more non-transitory computer-readable media of claim 12, wherein processing the plurality of vision tokens, the plurality of LiDAR tokens, the robot size, and the look-at pose comprises:
generating, based on the robot size and using a first neural network, a plurality of robot size tokens;
generating, based on the look-at pose and using a second neural network, a plurality of look-at pose tokens; and
generating, based on the plurality of robot size tokens and the plurality of look-at pose tokens, the plurality of context tokens.

14. The one or more non-transitory computer-readable media of claim 11, wherein a first trained decoder included in the one or more trained decoders comprises at least one of a transformer decoder or a regression model.

15. The one or more non-transitory computer-readable media of claim 11, wherein processing the plurality of context tokens comprises determining, based on the plurality of context tokens and using a first trained decoder included in the one or more trained decoders, a camera tilt.

16. The one or more non-transitory computer-readable media of claim 15, wherein the first trained decoder comprises a multi-token classification technique with a residual model.

17. The one or more non-transitory computer-readable media of claim 11, wherein processing the plurality of context tokens comprises:
generating, based on the plurality of context tokens, a plurality of cross-attention features; and
generating, based on the plurality of cross-attention features and using a first trained decoder included in the one or more trained decoders, a trajectory for the robot.

18. The one or more non-transitory computer-readable media of claim 17, wherein the trajectory includes one or more waypoints in egocentric polar coordinates.

19. The one or more non-transitory computer-readable media of claim 11, wherein a first trained encoder included in the one or more trained encoder receives as input camera extrinsics derived from odometry of the robot.

20. A system comprising:
one or more memories storing instructions, and
one or more processors that are coupled to the one or more memories and, when executing the instructions, are configured to:
receive sensor data and one or more goal specifications,
process the sensor data, a robot size, and the one or more goal specifications using one or more trained encoders to generate a plurality context tokens,
process the plurality of context tokens using one or more trained decoders to generate a robot plan, and
control a robot based on the robot plan.
